(19) United States
(12) Patent Application Publication
(10) Pub. No.: US 2011/0279039 A1
(43) Pub. Date: Nov. 17, 2011

(54) LASER DOWNLIGHT AND LASER DOWNLIGHT SYSTEM

(75) Inventor: Katsuhiko KISHIMOTO, Osaka-shi (JP)

(73) Assignee: SHARP KABUSHIKI KAISHA, Osaka-shi (JP)

(21) Appl. No.: 13/107,440

(22) Filed: May 13, 2011

(30) Foreign Application Priority Data
May 17, 2010 (JP) 2010-113482

(51) Int. Cl. H01J 7/24; H05B 37/02; H01S 3/00

(52) U.S. Cl. 315/113; 362/553; 315/294

(57) ABSTRACT

A laser downlight in accordance with the present invention includes: a laser diode for emitting a laser beam; an optical fiber having (i) an incidence end through which the optical fiber receives the laser beam emitted from the laser diode and (ii) an emitting end through which the optical fiber emits the laser beam received through the incidence end; and a light emitting section which emits light in response to the laser beam emitted through the emitting end. This achieves a small laser downlight that produces high luminous flux and consumes low electric power.

This Nonprovisional application claims priority under 35 U.S.C. §119(a) on Patent Application No. 2010-113482 filed in Japan on May 17, 2010, the entire contents of which are hereby incorporated by reference.

### TECHNICAL FIELD

The present invention relates to (i) a laser downlight including (a) a laser diode serving as an excitation light source and (b) a fluorescent material which generates fluorescence in response to excitation light emitted from the laser diode and (ii) a laser downlight system including the laser downlight.

### BACKGROUND ART

In recent years, a downlight has been attracting attention as an interior light for achieving a fashionable and high-grade lighting space, in place of an efficiency-oriented ceiling light using a fluorescent lamp. The downlight is a light recessed in a ceiling, and one of generally-known downlights is an incandescent bulb set in a hole on a ceiling.

Such a downlight is characterized for example in that, since the downlight is recessed in a ceiling and therefore the downlight itself cannot be seen from outside, it possible to make the ceiling look simple and spacious even if the desired number of downlights are installed in a desired location. Further, since the downlight itself is small in size, the downlight has been used also as a light in a small space such as a hallway or an entrance hall.

The downlight is characterized also in that it illuminates only a relatively small area immediately below it. In view of this, generally, one (1) downlight is not used alone to illuminate an entire room; instead, a large number of downlights are used to illuminate the entire room or a downlight(s) is used as an auxiliary light to another illuminating device. Further, the downlight makes it possible to create bright and dark portions within a room. This adds a good atmosphere to a room, and thus makes it possible to create a fashionable space with atmosphere.

Patent Literature 1 discloses a technique relevant to such a conventional downlight. Specifically, Patent Literature 1 discloses an illuminating device and an emergency light each of which includes an LED (light-emitting diode) and a reflective member that reflects light emitted from the LED.

### CITATION LIST

### Patent Literature

Patent Literature 1

Japanese Patent Application Publication, Tokukai, No. 2009-104913 A (Publication Date: May 14, 2009)

### SUMMARY OF INVENTION

### Technical Problem

However, the foregoing conventional downlight has the following problems. The following description first discusses problems unique to a conventional downlight including an incandescent bulb (such a conventional downlight is hereinafter referred to as an “incandescent bulb downlight”).

First, the incandescent bulb downlight consumes relatively high electric power because it includes the incandescent bulb. Secondly, the incandescent bulb downlight requires, for the purpose of preventing fire due to heat of the incandescent bulb from occurring in a space above a ceiling, vicinities of the incandescent bulb downlight in the space above the ceiling to be free from obstacles when the incandescent bulb downlight is installed on the ceiling.

As a solution to the first problem of high electric power consumption, a downlight including an LED (such a downlight is referred to as an “LED downlight”) has been attracting attention recently. The LED downlight consumes one-fifth to one-eighth as much electric power as that a conventional incandescent bulb downlight consumes.

However, such an LED downlight has the following problem which is unique to an LED.

That is, since a conventional LED downlight is configured such that a power supply circuit etc. for driving an LED is provided for each of LED downlights, total volume and weight of each of the LED downlights become large.

For example, each of the foregoing illuminating device and the emergency lamp of Patent Literature 1 is one example of such an LED downlight. The illuminating device and the emergency lamp have solved the problem of high electric power consumption by means of an LED. Note however that, according to the illuminating device and the emergency lamp, the LED and the reflective member etc. are provided inside the illuminating device or the emergency lamp such that they are integral with the illuminating device or the emergency lamp. This makes it difficult to reduce a size of the illuminating device or the emergency lamp itself. Even if a size of the reflective member is reduced, luminous flux from the reflective member will also be reduced.

The present invention has been made in view of the foregoing problems, and an object of the present invention is to provide a laser downlight and a laser downlight system each of which is small, is capable of producing high luminous flux, and consumes less electric power.

### Solution to Problem

In order to attain the above object, a laser downlight in accordance with the present invention includes: at least one (1) laser source for emitting a laser beam; a light guide section having (i) at least one (1) incidence end through which the light guide section receives the laser beam emitted from said at least one laser source and (ii) at least one (1) emitting end through which the light guide section emits the laser beam received through said at least one incidence end; and a light emitting section which emits light in response to the laser beam emitted through said at least one emitting end.

According to the configuration, the laser source that emits a laser beam is used as an excitation light source. This makes it possible to achieve a laser downlight which consumes electric power as low as that of an LED downlight, which is said to be capable of dramatically reducing electric power consumption as compared with an incandescent bulb downlight.

Further, according to the configuration, the laser beam emitted from the laser source enters the light guide section through the incidence end and is emitted from the light guide section through the emitting end. Note here that the laser beam emitted from the laser source is coherent and highly directional. Therefore, an area irradiated with the laser beam emitted from the laser source is smaller than that in a case of an LED etc. As such, the incidence end of the light guide section can receive through the incidence end the almost entire laser beam emitted from the laser source, although how much of the laser beam is received by the light guide section depends on a positional relation between the laser source and the light guide section.

Further, according to the configuration, the light emitting section emits light in response to the laser beam emitted through the emitting end of the light guide section. That is, the light emitting section includes at least a fluorescent material that emits light in response to a laser beam.

Accordingly, it is possible to cause the laser beam to strike the light emitting section, which is as large as the area irradiated with the laser beam emitted from the light guide section through the emitting end. This allows for use of the laser beam without loss of the laser beam, thereby achieving a light emitting section smaller than an LED etc. while keeping high luminous flux of the light emitting section. Further, it is possible to separate the laser source and the light emitting section by a certain distance by for example changing a distance between the incidence end and the emitting end of the light guide section as needed. This makes it possible to improve design flexibility of the laser downlight. As such, it is possible to provide a downlight that can be easily installed even in the course of renovation of an already-built house (i.e., easily installed even after a house has been built).

As has been described, the present invention can achieve a downlight that is small, produces high luminous flux, and consumes less electric power.

This allows for easy substitution of an illuminating device in a room by a downlight system for example even in the course of renovation of an already-built house which originally has not taken into consideration the installation of the downlight.

Meanwhile, according to a conventional downlight including a fluorescent lamp (such a downlight is hereinafter referred to as a “fluorescent downlight”), a fluorescent lamp serving as a light emitting section is extremely large in size. Accordingly, the fluorescent downlight causes a secondary problem in which it is not possible to create a sharply defined shadow.

Further, according to a conventional LED downlight, each LED produces small luminous flux. Therefore, the LED downlight needs to include a plurality of LEDs for the purpose of producing sufficient luminous flux. As a result, a plurality of luminous points are made, and eventually, such an LED downlight also causes the foregoing secondary problem in which it is not possible to create a sharply defined shadow, which is one of important characteristics of the downlight.

In this regard, as described above, the laser downlight in accordance with the present invention includes a laser source which has an optical output power higher than that of an LED. Therefore, the light emitting section of the laser downlight can be made smaller than the LED etc. while keeping its high luminous flux. Accordingly, it is possible to provide a laser downlight which achieves a sufficient lighting intensity with a single luminous point (light emitting section), without having to provide a plurality of luminous points. Accordingly, it is possible to achieve a high-grade downlight which is capable of creating a sharply defined shadow like an incandescent bulb such as for example a conventional miniature krypton bulb.

Note here that, in a case where the “laser source” includes a solid-state light source such as an LD chip, the number of the solid-state light source can be two or more. The solid-state light source can be (i) the one with a single stripe per chip or (ii) the one with plural stripes per chip.

As described above, the “light emitting section” includes at least a fluorescent material. Note here that (i) one type of a fluorescent material can be used alone or (ii) two or more types of fluorescent materials can be used. Further, the light emitting section can be constituted by dispersing one type or two or more types of fluorescent materials into a suitable dispersion medium.

### Advantageous Effects of Invention

As described above, a laser downlight in accordance with the present invention includes: at least one (1) laser source for emitting a laser beam; a light guide section having (i) at least one (1) incidence end through which the light guide section receives the laser beam emitted from said at least one laser source and (ii) at least one (1) emitting end through which the light guide section emits the laser beam received through said at least one incidence end; and a light emitting section which emits light in response to the laser beam emitted through said at least one emitting end.

Therefore, it is possible to achieve a downlight that is small, produces high luminous flux, and consumes less electric power.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram illustrating how a downlight system of one embodiment in accordance with the present invention is configured.

FIG. 2(a), showing the downlight system, is a view schematically illustrating one example of an emitting end of an optical fiber and one example of an exit part of a nozzle.

FIG. 2(b) is a view illustrating another example of the emitting end of the optical fiber and another example of the exit part of the nozzle.

FIG. 3(a), showing the downlight system, is a view schematically illustrating one example of how laser sources and a light emitting unit <light emitting sections> are connected with each other.

FIG. 3(b) is a view schematically illustrating another example of how the laser sources and the light emitting unit are connected with each other.

FIG. 3(c) is a view schematically illustrating a further example of how the laser sources and the light emitting unit are connected with each other.

FIG. 4(a) is a distribution chart illustrating light intensity distribution of laser beams emitted from optical fibers through respective emitting ends.

FIG. 4(b), showing the downlight system, is a view schematically illustrating a positional relation between a plurality of irradiated areas on a light emitting section.

FIG. 5 is a graph, for the light emitting section, which shows temperature characteristics versus emission intensity obtained in a case where fluorescent materials of different types are irradiated with laser beams having identical light intensity.

FIG. 6(a), showing the downlight system, is a view schematically illustrating a circuit of a laser diode.

FIG. 6(b) is a perspective view illustrating a basic structure of the laser diode.

FIG. 7, showing the laser downlight system, is a perspective view illustrating one example of how the laser diode is configured.

FIG. 8, showing one embodiment of a laser downlight in accordance with the present invention, is a view schematically illustrating overview of a light emitting unit of the laser downlight and overview of a conventional LED downlight.

FIG. 9 is a cross-sectional view illustrating a ceiling on which the laser downlight is installed.

FIG. 10 is a cross-sectional view illustrating the laser downlight.

FIG. 11 is a cross-sectional view illustrating a modification of how the laser downlight is installed.

FIG. 12 is a cross-sectional view illustrating a ceiling on which the conventional LED downlight is installed.

FIG. 13 is a table comparing specifications of the laser downlight and the conventional LED downlight.

### DESCRIPTION OF EMBODIMENTS

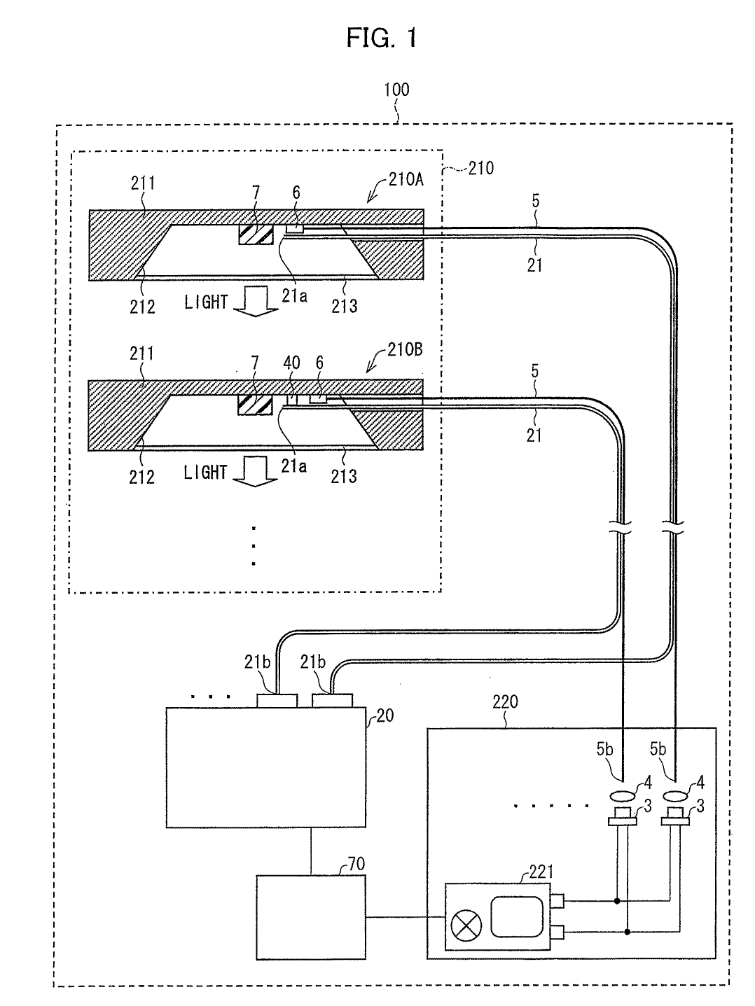

The following description discusses embodiments of the present invention with reference to FIGS. 1 through 13. Note here that, although some configurations may not be described as appropriate in one embodiment, the configurations are same as those described in the other embodiment. Further, for convenience of description, members having functions identical to those described in one embodiment are assigned identical referential numerals in the other embodiment, and their descriptions are omitted in the other embodiment.

### 1. First Embodiment

The following description discusses, with reference to FIGS. 1 through 7, how a laser downlight system (laser downlight) 100, which is one embodiment of the present invention, is configured.

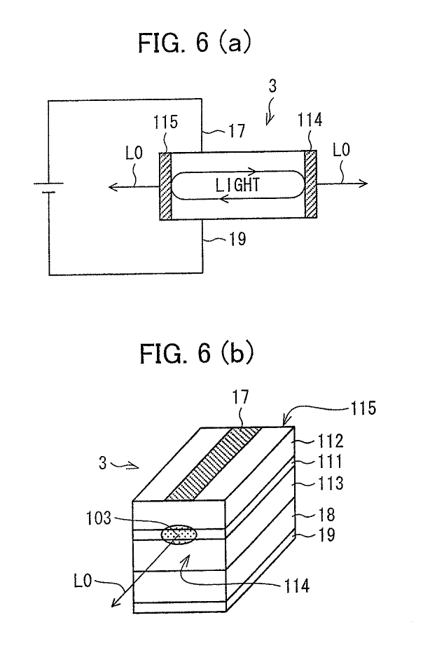

The laser downlight system 100 is an illumination system including a plurality of light emitting units (laser downlights), which are to be installed on a ceiling of a structural object such as a house or a vehicle. The laser downlight system 100 uses, as illumination light, fluorescence that a light emitting section 7 provided inside each of the plurality of light emitting units generates in response to a laser beam L0 emitted from a corresponding one of a plurality of laser diodes (laser sources) 3 (refer to FIG. 6 (a) and FIG. 6 (b)).

Note that light emitting units of an illumination system, which has a configuration same as that of the laser downlight system 100, can be installed on a wall or on a floor of a structural object. Where to install the light emitting units is not particularly limited.

FIG. 1 is a block diagram illustrating overall configuration of the laser downlight system 100.

As illustrated in FIG. 1, the laser downlight system 100 includes (i) a light emitting unit group (laser downlights) 210, (ii) an LD light source unit 220, (iii) a cooling unit (cooling section, air sending section) 20, and (iv) an air volume control unit (air volume control section) 70.

The light emitting unit group 210 is constituted by the plurality of light emitting units, at least two of which are a light emitting unit (laser downlight) 210A and a light emitting unit (laser downlight) 210B.

The LD light source unit 220 includes (i) the plurality of laser diodes 3 respectively corresponding to the light emitting unit 210A, the light emitting unit 210B, . . . and so on, (ii) a plurality of aspheric lenses 4 which collimate laser beams L0 emitted from the respective plurality of laser diodes 3, and (iii) a power supply unit (electric power control section) 221.

Each of the plurality of laser diodes 3 includes a chip having one (1) luminous point. For example, each of the laser diodes 3 emits a laser beam L0 having a wavelength of 405 nm (blue-violet), and its optical output is 1.0 W, operating voltage is 5 V, and operating current is 0.6 A. Each of the plurality of laser diodes 3 is sealed in a package of 5.6 mm in diameter. A wavelength of the laser beam L0 emitted from each of the laser diodes 3 is not limited to 405 nm as long as the laser beam L0 has a peak wavelength falling within a range of not less than 380 nm but not more than 470 nm. In a case where it is possible to prepare a good-quality laser diode for short wavelengths which emits a laser beam L0 having a wavelength shorter than 380 nm, such a laser diode can also be used as each of the laser diodes 3 of the present embodiment.

The plurality of aspheric lenses 4 cause the laser beams L0 emitted from the respective plurality of laser diodes 3 to enter optical fibers 5 through respective corresponding one ends, which serve as incidence ends Sb. One example of each of the plurality of aspheric lenses 4 is FLKN1 405 manufactured by ALPS ELECTRIC CO., LTD. Each of the plurality of aspheric lenses 4 is not limited as to its shape and material as long as the each of the plurality of aspheric lenses 4 has the above function; however, it is preferable that the each of the plurality of aspheric lenses 4 be made from a material that has (i) a high transmittance for a wavelength of approximately 405 nm, which is a wavelength of an excitation light and (ii) excellent heat resistance.

The optical fibers 5 are light guides which guide the laser beams L0 emitted from the respective plurality of laser diodes 3 to the respective corresponding light emitting sections 7. Each of the optical fibers 5 has (i) an incidence end 5b through which the each of the optical fibers 5 receives a laser beam L0 and (ii) an emitting end 5a through which the each of the optical fibers 5 emits the laser beam L0 received through the incidence end 5b.

Each of the optical fibers 5 has a double-layered structure, which includes (i) a center core and (ii) a clad which surrounds the core and has a refractive index lower than that of the core. The core is made mainly of fused quartz (silicon oxide), which absorbs little laser beam L0 and thus prevents a loss of the laser beam L0. The clad is made mainly of fused quartz or synthetic resin material, which has a refractive index lower than that of the core. For example, each of the optical fibers 5 is made of quartz, has a core of 200 μm in diameter, a clad of 240 μm in diameter, and numerical apertures (NA) of 0.22. Note, however, that a structure, diameter, and material of each of the optical fibers 5 are not limited to those described above. Each of the optical fibers 5 can have a rectangular cross-sectioned surface, which is perpendicular to a longitudinal direction of the each of the optical fibers 5.

The light guides can be materials other than optical fibers. Alternatively, the light guides can be a combination of an optical fiber and a material other than the optical fiber. The light guides can be of any type as long as each of the light guides has (i) an incidence end through which the each of the light guides receives a laser beam L0 emitted from a corresponding one of the plurality of laser diodes 3 and (ii) an emitting end through which the each of the light guides emits the laser beam L0 received through the incidence end.

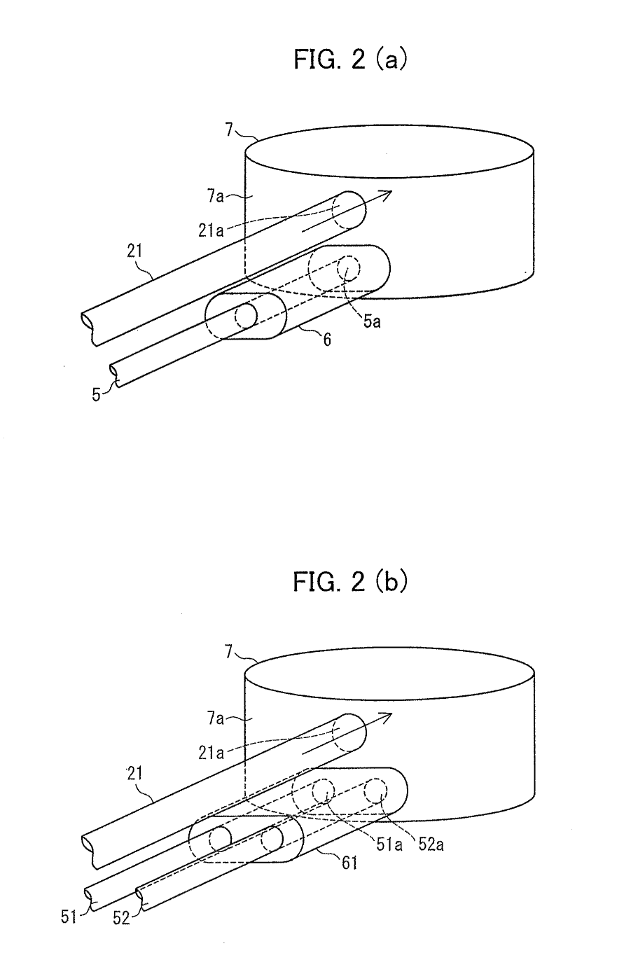

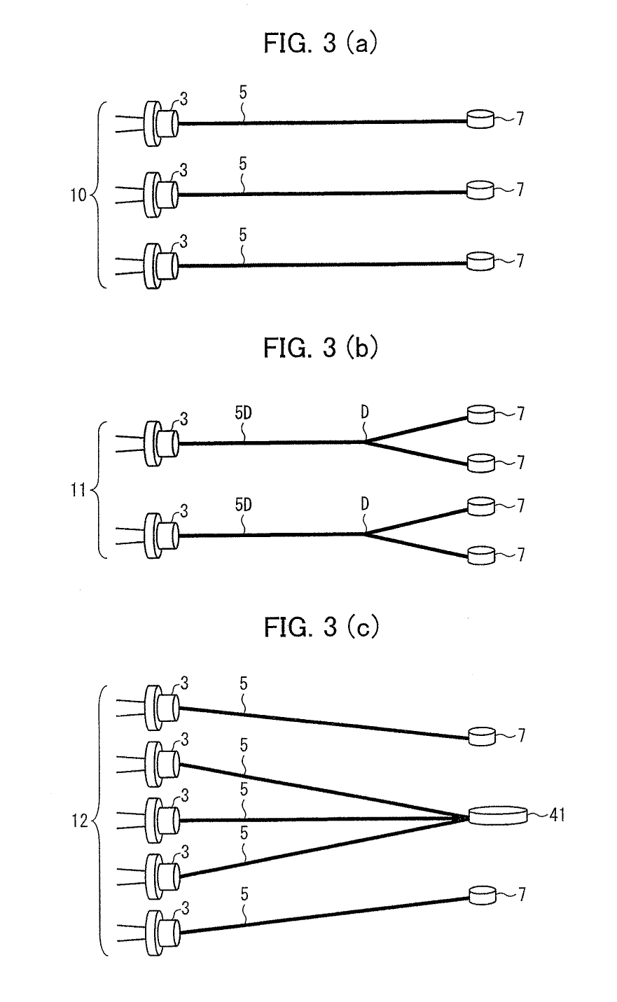

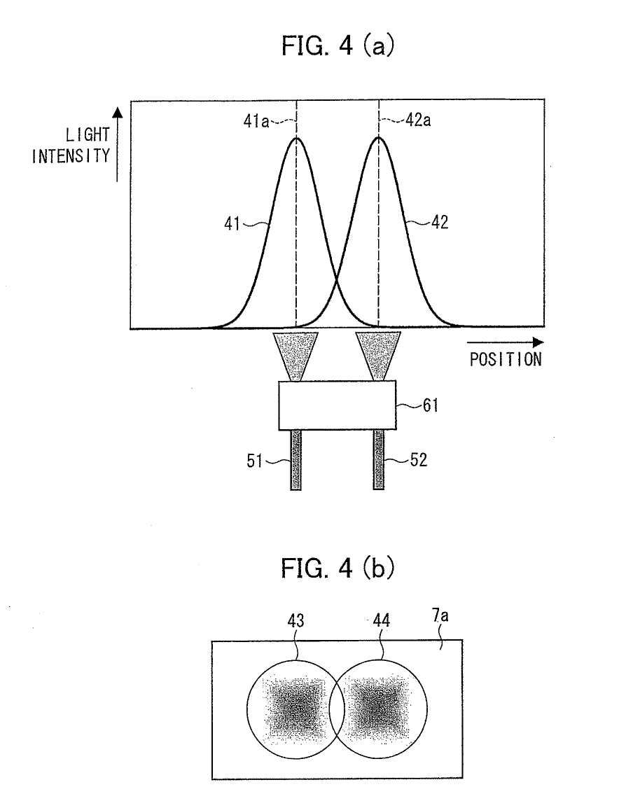

According to the present embodiment, a laser beam L0 emitted from one (1) laser diode 3 is guided to one (1) light emitting section 7 through one (1) optical fiber 5. Note, however, that the following configuration is also available. That is, all of laser beams L0 emitted from the plurality of laser diodes 3 are guided to one (1) light emitting section 7 through the respective optical fibers 5 (refer to FIG. 2(b), elliptic cylindrical light emitting material 41 FIG. 3(c), and FIG. 4(b)).

This makes it possible to further increase luminous flux and luminance of the light emitting section 7 according to the number of the plurality of laser diodes 3.

The power supply unit 221 supplies electric power to each of the plurality of laser diodes 3 such that a controlled amount of electric power is supplied to the each of the plurality of laser diodes 3.

Specifically, the power supply unit (electric power control section) 221 is configured so as to collectively manage electric power supply (or amount of electric power to be supplied) to the plurality of laser diodes 3, and functions as a centralized power source box. The power supply unit 221 is preferably configured so as to control electric power supply (or amount of electric power to be supplied) for each of the plurality of laser diodes 3. This makes it possible to control electric power supply (or amount of electric power to be supplied) for each of the light emitting unit 210A, the light emitting unit 210B, . . . and so on, thereby making it possible to set intensity (or electric power consumption) as appropriate for each of the light emitting unit 210A, the light emitting unit 210B, . . . and so on.

The light emitting unit 210A, the light emitting unit 210B, . . . and so on are optically connected with the respective corresponding plurality of laser diodes 3 via the respective corresponding optical fibers 5.

Meanwhile, on the one hand a downlight is used alone, on the other hand a plurality of downlights are used in combination. In a case where a plurality of downlights are used in combination, for example the power supply unit 221 can be shared by the plurality of light emitting units, two of which are the light emitting unit 210A and the light emitting unit 210B. This makes it possible to reduce electric power consumption and device costs as compared with a conventional LED downlight, in which an electric power control section is provided for each of light emitting units.

Further, the LD light source unit 220 and its including power supply unit 221 can be separated from a downlight section, i.e., it is not necessary that the LD light source unit 220 and the power supply unit 221 be installed in a space above a ceiling. This makes it possible to achieve a small and light downlight section, thereby allowing for easy substitution of an illuminating device in a room by a downlight system even in the course of renovation of an already-built house which originally has not taken into consideration the installation of the downlight system.

The incidence end 5b, which is one end of each of the optical fibers (light guide sections) 5, is connected with the LD light source unit 220. A laser beam L0 emitted from each of the plurality of laser diodes 3 passes through a corresponding one of the plurality of aspheric lenses 4 and then enters a corresponding one of the optical fibers 5 through the incidence end 5b.

Each of the optical fibers 5 is one example of a light guide having flexibility. Examples of the light guide encompass not only an optical fiber but also a light guide tube having flexibility. Since the light guide has flexibility, it is possible to easily change a positional relation between the incidence end 5b and an emitting end 5a of each of the optical fibers 5, and thus possible to easily change a positional relation between the plurality of laser diodes 3 and the light emitting sections 7. Accordingly, it is possible to further improve design flexibility of the laser downlight system 100. As such, it is possible to provide a laser downlight system 100 that can be easily installed for example in the course of renovation of an already-built house (i.e., easily installed even after a house has been built).

Meanwhile, a conventional incandescent bulb downlight, a conventional fluorescent downlight, and a conventional white LED downlight have the following secondary problem. That is, since their light sources themselves such as an incandescent bulb, a fluorescent lamp, and a white LED are main sources of heat generation, use of such downlights will reduce cooling efficiency of a room.

In this regard, according to the laser downlight system 100 of the present embodiment, for example the light emitting unit group (light emitting section) 210 to be installed on a ceiling and the plurality of laser diodes 3 can be optically connected with each other via for example the optical fibers 5 having flexibility, and thus can be spatially separated from each other. As such, it is possible to prevent much heat from being radiated to a space above the ceiling (e.g., a gap between a top board and a heat insulating material).

This makes it possible to provide a laser downlight system 100 which does not reduce cooling efficiency of a room and thus keeps a comfortable temperature during the summer. Further, from a viewpoint of total heating and lighting expenses, such an advantage, in which cooling efficiency of a room is not reduced, will further reduce electric power consumption as compared with an illumination system including a conventional LED downlight.

The light emitting unit 210A, the light emitting unit 210B, . . . and so on are connected with the cooling unit 20 via nozzles (cooling section, air guide sections) 21.

Each of the nozzles 21 is preferably made from a material having flexibility. This allows for easy change of a positional relation between an entrance part 21b and an exit part 21a of each of the nozzles 21, thereby allowing for easy change of a positional relation between the cooling unit 20 and the light emitting sections 7. This makes it possible to improve design flexibility of the laser downlight system 100.

This further makes it possible to separate the light emitting unit group 210, the LD light source unit 220, the cooling unit 20, and the air volume control unit 70 from one another by certain distances. Accordingly, it is possible to improve design flexibility of the laser downlight system 100.

Accordingly, for example the LD light source unit 220, the cooling unit 20, and the air volume control unit 70 do not need to be provided on the ceiling. Therefore, the LD light source unit 220, the cooling unit 20, and the air volume control unit 70 can be provided in another location (e.g., on a wall of a house) so that a user can readily reach them.

That is, since a length of each of the optical fibers 5 and each of the nozzles 21 can be set as appropriate, it is possible to provide a laser downlight system 100 that can be easily installed even in the course of renovation of an already-built house (i.e., easily installed even after a house has been built).

The cooling unit 20 generates a certain volume of an air current, which is caused to enter each of the nozzles 21 through the entrance part 21b. The air current is then guided to an area (i.e., vicinity of a temperature rising area) in front of a laser beam-irradiated surface 7a of each of the light emitting sections 7 of the respective plurality of light emitting units (i.e., the light emitting unit 210A, the light emitting unit 210B, . . . and so on).

The air current thus guided is ejected from each of the nozzles 21 through the exit part 21a so as to blow against (i.e., so as to cool) the temperature rising area, which includes an irradiated area of a corresponding one of the light emitting sections 7 and vicinities of the irradiated area.

Each of the light emitting sections 7 emits fluorescence in response to a laser beam L0. This causes a little increase in a temperature of an area which includes the irradiated area of the each of the light emitting sections 7 and vicinities of the irradiated area (that is, such an area is the temperature rising area). That is, the cooling unit 20 is the one which cools the temperature rising area so as to suppress an increase in the temperature of the temperature rising area.

Since the cooling unit 20 suppresses an increase in a temperature of the temperature rising area of each of the light emitting sections 7, it is also possible to prevent a deterioration due to heat generation of the light emitting sections 7. Accordingly, it is possible to achieve a long-life laser downlight system 100 whose life is as long as or longer than that of an LED downlight. That is, with such a long-life laser downlight system 100, it is not necessary to replace downlights almost permanently unlike incandescent bulb downlights for which their incandescent bulbs need to be often replaced.

The air volume control unit 70 controls, in accordance with an amount of electric power that the power supply unit 221 of the LD light source unit 220 supplies to each of the laser diodes 3, the cooling unit 20 so that the cooling unit 20 generates a controlled volume of an air current. This makes it possible to suppress excess electric power consumption due to generation of an unnecessary volume of an air current.

Meanwhile, in some cases, a plurality of light emitting units (i.e., downlights) are used in combination like the laser downlight system 100 of the present embodiment.

In such cases, for example, the power supply unit 221 can be shared by the plurality of light emitting units. This makes it possible to reduce electric power consumption and device costs as compared with a conventional LED downlight, in which a power supply circuit is provided for each of light emitting units.

Further, according to the laser downlight system 100, it is possible to supply electric power collectively from one (1) power supply unit 221 to the plurality of laser diodes 3. Thereby, it is also possible to collectively control the plurality of light emitting units so that they emit controlled level of lights.

Further, it is possible to supply air currents generated by the cooling unit 20 to the plurality of light emitting units via the nozzles 21. This makes it possible to dramatically reduce a size of the downlight section (i.e., a size of each of the light emitting sections 7) as compared with a conventional downlight, in which a cooling unit is provided for each of light emitting units.

Further, the plurality of laser diodes 3, the power supply unit 221, and the cooling unit 20 can be separated from the downlight section, i.e., it is not necessary that the plurality of laser diodes 3, the power supply unit 221, and the cooling unit 20 be installed in a space above a ceiling. This makes it possible to achieve an extremely small and light downlight section, thereby allowing for easy substitution of an illuminating device in a room by a downlight system even in the course of renovation of an already-built house which originally has not taken into consideration the installation of the downlight system.

### (Example of Configuration of Light Emitting Unit)

The following description specifically discusses how the light emitting unit 210A and the light emitting unit 210B, which constitute the light emitting unit group 210, are configured.

First, as illustrated in FIG. 1, the light emitting unit 210A includes an outer housing 211, a corresponding one of the optical fibers 5, a ferrule 6, a corresponding one of the nozzles 21, a corresponding one of the light emitting sections 7, and a light transmitting plate 213.

The outer housing 211 has a recess part 212. The corresponding one of the light emitting sections 7 is provided on a bottom surface of the recess part 212. The recess part 212 functions as a reflection mirror because a surface of the recess part 212 is covered with a thin metal film. A shape of the outer housing 211 is not particularly limited.

The outer housing 211 has a passageway which the corresponding one of the optical fibers 5 and the corresponding one of the nozzles 21 are caused to pass through. The corresponding one of the optical fibers 5 and the corresponding one of the nozzles 21 extend through the passageway so that the emitting end 5a (not illustrated) of the corresponding one of the optical fibers 5 and the exit part 21a of the corresponding one of the nozzles 21 reach the corresponding one of the light emitting sections 7. One end, of the corresponding one of the optical fibers 5, which is in front of the corresponding one of the light emitting sections 7 is held by the ferrule 6. Although the ferrule 6 holds the one end of the corresponding one of the optical fibers 5 according to the present embodiment, the ferrule 6 can also hold the corresponding one of the nozzles 21. In that case, the ferrule 6 can have two through holes for the corresponding one of the optical fibers 5 and the corresponding one of the nozzles 21, respectively.

The light transmitting plate 213 is a transparent or semitransparent plate provided so as to cover an opening of the recess part 212. The light transmitting plate 213 is provided on an optical path from a corresponding one of the plurality of laser diodes 3 to outside the light emitting unit 210A. It is preferable that the light transmitting plate 213 be made from a material that (i) blocks a laser beam L0 from the corresponding one of the plurality of laser diodes 3 and (ii) transmits white light (incoherent light) generated from the corresponding one of the light emitting sections 7 through conversion of the laser beam L0.

Note here that the almost entire laser beam L0, which is coherent light, is converted into incoherent white light by the corresponding one of the light emitting sections 7. However, part of the laser beam L0 may not be converted for some reasons. Even in that case, it is possible to prevent the laser beam L0 from leaking out because the light transmitting plate 213 blocks the laser beam L0.

The following description specifically discusses how the light emitting unit 210B is configured. As illustrated in FIG. 1, the light emitting unit 210B is different from the light emitting unit 210A only in that the light emitting unit 210B further includes an irradiation lens (convex lens or concave lens) 40 between the ferrule 6 and a corresponding one of the light emitting sections 7.

The irradiation lens 40 can be a convex lens having a convex surface facing the corresponding one of the light emitting sections 7 or a concave lens having a concave surface facing the corresponding one of the light emitting sections 7.

Examples of the irradiation lens 40 encompass (i) a biconvex lens, a plano-convex lens, and a convex meniscus lens, each of which has a convex surface facing the corresponding one of the light emitting sections 7 and (ii) a biconcave lens, a plano-concave lens, and a concave meniscus lens, each of which has a concave surface facing the corresponding one of the light emitting sections 7.

Alternatively, depending on a shape of the corresponding one of the light emitting sections 7, the irradiation lens 40 can be (i) a combination of an independent lens which has a certain optical axis and a concave surface and an independent lens which has a certain optical axis and a concave surface, (ii) a combination of independent lenses each of which has a certain axis and a convex surface, (iii) a combination of independent lenses each of which has a certain axis and a concave surface, or the like.

Accordingly, it is possible to employ a combination of lenses suitable for the shape of the corresponding one of the light emitting sections 7, and thus possible to increase efficiency of light emission from the corresponding one of the light emitting sections 7.

Alternatively, depending on the shape of the corresponding one of the light emitting sections 7, the irradiation lens 40 can be (i) a compound lens which has a certain axis and is constituted by a lens having a concave surface and a lens having a convex surface, which lenses are integral with each other, (ii) a compound lens which has a certain axis and is constituted by lenses each having a convex surface, which lenses are integral with each other, (iii) a compound lens which has a certain axis and is constituted by lenses each having a concave surface, which lenses are integral with each other, or the like.

Accordingly, it is possible to employ a compound lens suitable for the shape of the corresponding one of the light emitting sections 7 while reducing the number of parts of an entire optical system and a size of the entire optical system, and thus possible to increase efficiency of light emission from the light emitting section 7.

Other examples of the irradiation lens 40 encompass a GRIN lens (Gradient Index lens) and the like.

Note that the GRIN lens is a lens which does not have a convex or concave shape but functions as a lens because it has a refractive index gradient.

Accordingly, for example, it is possible to cause the GRIN lens to have a flat end surface while keeping its lens function. This makes it possible to attach, without a gap, the end surface of the GRIN lens to for example an end surface of a light emitting section having a shape of a rectangular parallelepiped.

As has been described, the laser downlight system 100 uses, as excitation light sources, the plurality of laser diodes 3 each of which emits a laser beam L0. Accordingly, it is possible to achieve electric power consumption as low as that of an LED downlight, which is said to be capable of dramatically reducing electric power consumption as compared with an incandescent bulb downlight.

Each of the light emitting sections 7 is optically connected with a corresponding one of the plurality of laser diodes 3 via a corresponding one of the optical fibers 5.

Note here that a laser beam L0 emitted from each of the plurality of laser diodes 3 is coherent light and is highly directional. Therefore, an area irradiated with the laser beam L0 emitted from the each of the plurality of laser sources 3 is smaller than that in a case of an LED etc. As such, each of the optical fibers 5 can receive through its incidence end 5b an almost entire laser beam L0 emitted from a corresponding one of the plurality of laser diodes 3, although how much of the laser beam L0 is received by the each of the optical fibers 5 depends on a positional relation between the corresponding one of the plurality of laser diodes 3 and the each of the optical fibers 5.

Further, each of the light emitting sections 7 is configured so as to emit light in response to the laser beam L0, which is emitted from a corresponding one of the optical fibers 5 through its emitting end 5a. That is, each of the light emitting sections 7 includes at least a fluorescent material which generates fluorescence (light) in response to the laser beam L0.

According to this configuration, it is possible to cause a laser beam L0 to strike each of the light emitting sections 7, which is as large as the area irradiated with the laser beam L0 emitted through the emitting end 5a. This allows for use of the laser beam L0 without loss of the laser beam L0, thereby achieving a light emitting section 7 smaller than an LED etc. while keeping high luminous flux of the light emitting section 7. Further, it is possible to separate the plurality of laser diodes 3 from the light emitting sections 7 by a certain distance by for example changing a distance between the incidence end 5b and the emitting end 5a of each of the optical fibers 5 as needed. This makes it possible to improve design flexibility of the laser downlight system 100.

As such, it is possible to achieve a small laser downlight system 100 which has high luminous flux and consumes low electric power.

This allows for easy substitution of an illuminating device in a room by a downlight system for example even in the course of renovation of an already-built house which originally has not taken into consideration the installation of the downlight system.

Meanwhile, according to a conventional fluorescent downlight, a fluorescent lamp serving as a light emitting section is extremely large in size. As a result, the fluorescent downlight causes a secondary problem in which it is not possible to create a sharply defined shadow.

Further, a conventional LED downlight needs to include a plurality of LEDs for the purpose of producing sufficient luminous flux. As a result, a plurality of luminous points are made, and eventually, such an LED downlight also causes the foregoing secondary problem in which it is not possible to create a sharply defined shadow.

In this regard, as described earlier, the laser downlight system 100 includes the plurality of laser diodes 3, each of which has an optical output power higher than that of an LED. Therefore, each of the light emitting sections 7 of the laser downlight system 100 can be made smaller than the LED etc. while keeping its high luminous flux. Accordingly, it is possible to provide a laser downlight which achieves a sufficient lighting intensity with a single luminous point (light emitting section 7), without having to provide a plurality of luminous points (light emitting sections 7). As such, it is possible to achieve a high-grade laser downlight system 100 which is capable of creating a sharply defined shadow like an incandescent bulb such as for example a conventional miniature krypton bulb.

Note here that, in a case where each of the plurality of “laser diodes 3” includes a solid-state light source such as an LD chip, the number of the solid-state light source can be two or more. The solid-state light source can be (i) the one with a single stripe per chip or (ii) the one with plural stripes per chip.

### (Configuration of Light Emitting Section 7)

Each of the light emitting sections 7 emits light in response to a laser beam L0 emitted through the emitting end 5a. Each of the light emitting sections 7 includes a fluorescent material which emits light in response to the laser beam L0. Note here that (i) one type of a fluorescent material can be used alone or (ii) two or more types of fluorescent materials can be used.

Each of the light emitting sections 7 can be constituted by dispersing one type or two or more types of fluorescent materials into a suitable dispersion medium. More specifically, each of the light emitting sections 7 can be made of silicone resin which serves as a fluorescent material-holding substance and in which fluorescent materials are dispersed.

A ratio of the silicone resin to the fluorescent materials is approximately 10:1. Each of the light emitting sections 7 can be made also by ramming the fluorescent materials. The fluorescent material-holding substance is not limited to the silicone resin, and can be so-called organic-inorganic hybrid glass or inorganic glass.

The fluorescent materials include an oxynitride fluorescent material and/or a nitride fluorescent material. The fluorescent materials, which are dispersed in the silicone resin, are blue, green, and red fluorescent materials. Since each of the plurality of laser diodes 3 emits a laser beam L0 at a wavelength of 405 nm (blue-violet), a corresponding one of the light emitting sections 7 emits white light in response to the laser beam L0 emitted from the each of the plurality of laser diodes 3. In view of this, each of the light emitting sections 7 can be regarded as being a wavelength conversion material.

Each of the plurality of laser diodes 3 can also be the one that emits a laser beam L0 at a wavelength of 450 nm (blue) or the one that emits a laser beam L0 having a peak wavelength falling within a range of not less than 440 nm but not more than 490 nm (close to so-called “blue”). In this case, the fluorescent materials should include (i) yellow fluorescent materials or (ii) a mixture of green and red fluorescent materials. Note here that the yellow fluorescent materials are fluorescent materials each of which emits light having a peak wavelength falling within a range of not less than 560 nm but not more than 590 nm. The green fluorescent materials are fluorescent materials each of which emits light having a peak wavelength falling within a range of not less than 510 nm but not more than 560 nm. The red fluorescent materials are fluorescent materials each of which emits light having a peak wavelength falling within a range of not less than 600 nm but not more than 680 nm.

Each of the fluorescent materials is preferably a material called a sialon fluorescent material or a nitride fluorescent material. Note here that sialon is silicon nitride in which (i) one or more of silicon atoms are substituted by an aluminum atom(s) and (ii) one or more of nitrogen atoms are substituted by an oxygen atom(s). The sialon fluorescent material can be produced by solidifying almina (Al₂O₃), silica (SiO₂), a rare-earth element, and/or the like with silicon nitride (Si₃N₄).

Another preferable example of each of the fluorescent materials is a semiconductor nanoparticle fluorescent material, which includes nanometer-size particles of a III-V group compound semiconductor. The semiconductor nanoparticle fluorescent material is characterized in that, for example, even if the nanoparticles are made of an identical compound semiconductor (e.g., indium phosphorus: InP), it is possible to cause the nanoparticles to emit light of different colors by changing particle size of the nanoparticles. The change in color occurs due to a quantum size effect. For example, in the case where the semiconductor nanoparticle fluorescent material is made of InP, the semiconductor nanoparticle fluorescent material emits red light when each of the nanoparticles is approximately 3 nm to 4 nm in diameter. Note here that the particle size is evaluated with use of a transmission electron microscope (TEM).

Further, the semiconductor nanoparticle fluorescent material is a semiconductor-based material, and therefore a life of fluorescence is short. Accordingly, the semiconductor nanoparticle fluorescent material can quickly convert power of excitation light into fluorescence, and therefore is highly resistant to a high-power laser beam. This is because an emission life of the semiconductor nanoparticle fluorescent material is approximately 10 nanoseconds, which is some five digits less than a generally used fluorescent material that contains rare earth as a luminescence center. Since the emission life is short, it is possible to quickly repeat absorption of excitation light and emission of fluorescence.

Accordingly, it is possible to maintain high efficiency with respect to intense laser beams, thereby reducing heat emission from the fluorescent materials. This makes it possible to further prevent heat deterioration (discoloration and/or deformation) in a light conversion material. As such, it is possible to further prevent a reduction in a life of a light emitting device in a case where the light emitting device includes, as a light source, a high-power light emitting element.

Each of the light emitting sections 7 has a shape of for example a disc that is 5 mm in diameter and 1 mm in thickness. In this case, an area size of each of the light emitting sections 7 when seen from the opening of a corresponding one of the light emitting unit 210A and the light emitting unit 210B is approximately 20 mm².

Note that, according to the present embodiment, a peripheral wall (or the opening of the recess part 212) of the recess part 212 (described later) has a circular cross-sectional surface. With a combination of such a recess part 212 and a corresponding one of the light emitting sections 7 each having a shape of a disc, it is possible to achieve a circular light distribution pattern.

The shape of each of the light emitting sections 7 is not limited to a shape of a disc, and therefore can be for example a rectangular parallelepiped. In this case, with a combination of the each of the light emitting sections 7 each having a shape of a rectangular parallelepiped and the peripheral wall of the recess part 212 which has a circular cross-sectional surface, an oval light distribution pattern is achieved. The oval light distribution pattern can be utilized for example to illuminate a long hallway such that a longitudinal axis of the oval light distribution pattern extends in a direction in which the hallway extends.

### (Configuration Examples of Emitting End of Optical Fiber and Exit Part of Nozzle)

The following describes configuration examples of the emitting end 5a of each of the optical fibers 5 and the exit part 21a of each of the nozzles 21, with reference to FIG. 2(a) and FIG. 2(b).

The ferrule 6 illustrated in FIG. 2(a) has a single through hole so as to hold the emitting end 5a of a single optical fiber 5 against the laser beam-irradiated surface 7a of a corresponding one of the light emitting sections 7.

In contrast, a ferrule 61 illustrated in FIG. 2(b) has two horizontally-adjacent through holes so as to hold respective emitting ends 51a and 52a of two optical fibers 51 and 52 against the laser beam-irradiated surface 7a of a corresponding one of the light emitting sections 7.

As described above, the through holes of the ferrule are provided as many as optical fibers to be held by the ferrule, and the plurality of through holes are configured so as to hold the emitting ends of the optical fibers in a predetermined pattern in accordance with the shape of the corresponding one of the light emitting sections 7.

Each of the ferrules 6 and 61 can have through-hole(s) in a predetermined pattern so as to accommodate the emitting end(s) of the optical fiber(s), as is the case with the present embodiment. Alternatively, each of the ferrules 6 and 61 can be separable into an upper part and a lower part, each of which has on its joint surface grooves for sandwiching and accommodating the emitting end(s).

In the present embodiment, each of the ferrules 6 and 61 is fixedly joined to the bottom surface of the recess part 212 (see FIG. 1). A material of each of the ferrules 6 and 61 is not particularly limited, and can be for example stainless steel. A plurality of ferrules can be provided for one (1) light emitting section 7. Although FIG. 2(b) illustrates two emitting ends for convenience of description, the number of the emitting ends is not limited to two.

The exit part 21a of each of the nozzles 21 is disposed in such a position and such a direction that an air current from the cooling unit 20 reaches the temperature rising area on the laser beam-irradiated surface 7a of a corresponding one of the light emitting sections 7 (in the present embodiment, the exit part 21a of each of the nozzles 21 is provided such that the corresponding one of the light emitting sections 7 is on an extension of the exit part 21a).

In other words, each of the nozzles 21 includes: the entrance part 21b through which an air current generated by the cooling unit 20 enters the each of the nozzles 21; and an exit part 21a through which the air current entered through the entrance part 21b is ejected. The exit part 21a is disposed in the vicinity of the temperature rising area. This allows the laser downlight system 100 to send the air current generated by the cooling unit 20 to the temperature rising area of a corresponding one of the light emitting sections 7. Thus, the laser downlight system 100 can cool the temperature rising area by use of the air current.

The nozzles 21 of the present embodiment each have a linear shape (rod shape). However, a shape of each of the nozzles 21 is not limited to this. As is the case with the optical fibers 5, each of the nozzles 21 can be a tube which has flexibility and therefore is deformable (i.e., can be bent).

If the nozzles 21 have flexibility, it is possible to easily change a positional relation between the cooling unit 20 and each of the light emitting sections 7. Adjustment of lengths of the nozzles 21 makes it possible to provide the cooling unit 20 distantly from the light emitting sections 7. This makes it possible to provide the cooling unit 20 in a position where the cooling unit 20 can be easily repaired or replaced in the event of a fault. This makes it possible to increase design flexibility of the laser downlight system 100.

### (Connection Form Between Laser Light Source and Light Emitting Section <Light Emitting Unit>)

The following describes connection forms between laser sources and light emitting sections in the laser downlight system 100, with reference to FIG. 3(a) to (c).

The following omits to describe configurations other than the configurations of the laser sources and the light emitting sections. That is, the following deals with only the connection forms between the laser sources and the light emitting sections. The following assumes that one (1) light emitting section is provided in each of light emitting units.

Each of the forms illustrated in FIG. 3(a) to (c) assumes that: each of the light emitting units has a reflection mirror (not illustrated) having the recess part 212 for reflecting light emitted from a corresponding one of the light emitting sections (light emitting section 7 or elliptic cylindrical light emitting material 41); and the light emitting sections are provided in the respective recess parts 212.

FIG. 3(a) to (c) illustrate a configuration with three laser diodes 3, a configuration with two laser diodes 3, and a configuration with five laser diodes 3, respectively (such laser diodes 3 are hereinafter referred to as laser source groups 10, 11, and 12). The number of laser diodes 3 can be one or more than one.

FIG. 3 illustrates optical fibers 5 and branched optical fibers 5D, which are examples of the aforementioned light guides. However, the light guides are not limited to these and can be members such as light guide tubes.

The elliptic cylindrical light emitting material 41 has a major axis of 7 mm, a minor axis of 5 mm, and a thickness of 1 mm, and has a shape of an elliptic cylinder.

As is the case with the light emitting sections 7 and the elliptic cylindrical light emitting material 41 in FIG. 3(c), at least one of the plurality of light emitting sections can have a different shape from others, as described above.

Such a configuration, in which the light emitting sections have different shapes like above, makes it possible to form different light distribution patterns. Note here that the light distribution patterns are, for example, shapes of cut lines each of which determines a boundary between a bright area and a dark area of a light distribution pattern of light emitted from each of the light emitting sections (or light emitting units).

Thus, adjusting a shape of each of the light emitting sections as described above makes it possible to cause a corresponding one of the light emitting units to have a desired light distribution pattern.

As is the case with the light emitting sections 7 and the elliptic cylindrical light emitting material 41 in FIG. 3(c), at least one of the plurality of light emitting sections can have a different size from others.

In a case where one (1) light emitting section is so small that the light emitting section can be regarded as being a point light source, the light emitting section emits isotropic light which is not affected by the shape of the light emitting section.

For example, each of the light emitting sections 7 is smaller than the elliptic cylindrical light emitting material 41, and emits isotropic light which is not affected by the shape of the light emitting section 7.

On the other hand, in a case where one (1) light emitting section is so large that the light emitting section cannot be regarded as being a point light source, light emitted from the light emitting section is affected by the shape of the light emitting section so that the light distribution pattern of the light is lower in symmetrical property than the isotropic light.

For example, the elliptic cylindrical light emitting material 41 is larger than each of the light emitting sections 7, and emits light having a light distribution pattern which is lower in symmetrical property than the isotropic light because the light is affected by the elliptical shape of the elliptic cylindrical light emitting material 41.

Therefore, employing different sizes of the light emitting sections as described above makes it possible to form respective different light distribution patterns of the light emitting sections (or the light emitting units).

Each of the optical fibers 5 illustrated in FIG. 3(a) and (c) has a surrounded structure which is surrounded by a boundary surface (light reflecting side surface) between a core and a clad, which boundary surface reflects a laser beam L0. Each of the optical fibers 5 receives a laser beam L0 emitted from a corresponding one of the laser diodes 3 through its one end and guides the laser beam L0 through its other end to a corresponding one of the three light emitting sections 7. That is, the optical fibers 5 are different from the branched optical fibers 5D (described later) in that the optical fibers 5 have no branch point D.

The boundary surface between the core and the clad, which surface reflects the laser beam L0, makes it possible to prevent the laser beam L0 from leaking out of each of the optical fibers 5. This makes it possible to guide laser beams L0 to the respective plurality of light emitting sections 7 while preventing a decrease in use efficiency of the laser beams L0.

Each of the optical fibers 5 is an optical fiber made from quartz that has a core of 200 μm in diameter, a clad of 240 μm in diameter, and numerical aperture (NA) of 0.22.

FIG. 3(a) illustrates a configuration in which the number of the optical fibers 5 is three, which is the same as that of the laser diodes 3. Similarly, FIG. 3(c) illustrates a configuration in which the number of the optical fibers 5 is five, which is the same as that of the laser diodes 3.

On the other hand, each of the branched optical fibers 5D illustrated in FIG. 3(b) has a surrounded structure which is surrounded by a boundary surface between a core and a clad, which boundary surface reflects a laser beam L0. Each of the branched optical fibers 5D receives a laser beam L0 emitted from a corresponding one of the laser diodes 3 through its one end and guides the laser beam L0 through its two other ends to respective two of the light emitting sections 7. That is, each of the branched optical fibers 5D has a branch point D at which the optical path of the laser beam L0 is divided into two.

The boundary surface between the core and the clad, which surface reflects the laser beam L0, makes it possible to prevent the laser beam L0 from leaking out of each of the branched optical fibers 5. This makes it possible to guide laser beams L0 to the respective plurality of light emitting sections 7 while preventing a decrease in use efficiency of the laser beam L0.

Each of the branched optical fibers 5D is an optical fiber made from quartz that has a core of 200 μm in diameter, a clad of 240 μm in diameter, and numerical aperture (NA) of 0.22.

As has been described, with a simple method which uses the plurality of optical fibers 5 and/or the plurality of branched optical fibers 5D, it is possible to optically connect the plurality of laser diodes 3 with the plurality of light emitting sections 7 (or with the elliptic cylindrical light emitting materials 41) while preventing a decrease in use efficiency of the laser beams L0.

Generally, a bundle of a plurality of optical fibers 5 or a plurality of branched optical fibers 5D does not have a very large thickness although this depends on a diameter and the number of the optical fibers 5 or the branched optical fibers 5D.

In a case where another optical system (not illustrated) is provided between the laser diodes 3 and the light emitting sections 7 (or an elliptic cylindrical light emitting material 41), it is necessary to make a hole in the another optical system so as to cause the bundle of the plurality of optical fibers 5 or the plurality of branched optical fibers 5D to pass through the hole. In this regard, according to the present embodiment, it is not necessary to make many large holes in the another optical system. This makes it possible to prevent a deterioration in the function of the another optical system. Note that it is necessary to pay attention to the branch points D in a case where the bundle of the branched optical fibers 5D is caused to pass through the hole in the another optical system.

The following describes the connection forms between the laser sources and the light emitting sections in detail. The following patterns are examples of the connection forms between the laser sources and the light emitting sections, i.e., patterns of guiding light to a plurality of light emitting sections 7 via the optical fibers 5 and the branched optical fibers 5D.

The first pattern is such that it is possible to prepare a plurality of light emitting sections 7 and optical fibers of the same number. In this case, the laser diodes 3 are optically connected in a univalent correspondence with the light emitting sections 7.

The “univalent correspondence” encompasses (i) a case where the laser diodes 3 are in a one-to-one correspondence with the light emitting sections 7 (see FIG. 3(a)) and (ii) a case where some of the laser diodes 3 are in a one-to-one correspondence with corresponding ones of the light emitting sections 7 whereas the other ones of the laser diodes 3 are in a many-to-one correspondence with one of the light emitting sections 7 (in FIG. 3(c), a combination of a one-to-one correspondence and a three-to-one correspondence) (see FIG. 3(c)).

The “univalent correspondence” also encompasses a case where the laser diodes 3 are in a many-to-one correspondence with one (1) light emitting section 7 (such a case is not illustrated).

The “univalent correspondence” cases assume that each of the laser diodes 3 is optically connected with a corresponding one of the light emitting sections 7 via a corresponding one of the optical fibers 5, and the each of the laser diodes 3 is not optically connected with another one of the light emitting sections 7 via another one of the optical fibers 5.

For example, in the example of FIG. 3(c), there are (i) five laser diodes 3 and (ii) three light emitting sections 7 two of which are two light emitting sections 7 and the other one of which is one (1) elliptic cylindrical light emitting material 41. Each of the two light emitting sections 7 is optically connected in a one-to-one correspondence with respective two of the laser diodes 3, whereas the one elliptic cylindrical light emitting material 41 is optically connected in a one-to-three correspondence with the other three of the laser diodes 3.

That is, the “univalent correspondence” cases do not encompass a case where any one of the two light emitting sections 7 and the one elliptic cylindrical light emitting material 41 is optically connected in a one-to-five correspondence with the five laser diodes 3 and the other ones of the two light emitting sections 7 and the one elliptic cylindrical light emitting material 41 is optically connected with none of the laser diodes 3.

The second pattern is such that, as illustrated in FIG. 3(b), optical fibers are fewer than a plurality of light emitting sections 7. The following describes the pattern.

The case where “optical fibers are fewer than a plurality of light emitting sections 7” is, in other words, a case where at least one of the plurality of light emitting sections 7 is optically connected with none of the laser diodes 3 even in a case where optical fibers are prepared as many as the laser diodes 3 since the laser diodes 3 are fewer than the plurality of light emitting sections 7.

That is, in such a case, it is necessary that the optical fibers have a branch point D at which the optical path of the laser beam L0 is divided, like the branched optical fibers 5D.

The optical fibers are branched in accordance with the number of the at least one of the light emitting sections 7 which is optically connected with none of the laser diodes 3. This makes it possible to prevent each of the light emitting sections 7 from not being connected with any of the laser diodes 3 even if the optical fibers are fewer than the plurality of light emitting sections 7.

How each of the optical fibers is branched encompasses branching only one optical fiber, and branching each of two or more optical fibers as illustrated in FIG. 3(b).

Further, each of the optical fibers can have a branch point(s) such that the optical path of the laser beam L0 is divided into (i) two as illustrated in FIG. 3(b) or (ii) more than two.

Any of the first and second patterns makes it possible to prevent each of the light emitting sections 7 and the elliptic cylindrical light emitting material 41 from not receiving any of laser beams L0 emitted from the laser diodes 3.

In the example of FIG. 3(c), each of the light emitting sections 7 is optically connected in a one-to-one correspondence with one (1) laser diode 3. On the other hand, the elliptic cylindrical light emitting material 41 is optically connected in a one-to-three correspondence with three laser diodes 3.

Accordingly, an optical output power of a laser beam L0 with which the elliptic cylindrical light emitting material 41 is irradiated is approximately three times higher than that of a laser beam L0 with which each of the light emitting sections 7 is irradiated.

It is possible to cause a plurality of light emitting sections (or light emitting units) to have different luminous flux and luminance by changing, like above, an optical output power of each of laser lights L0 which strike the respective plurality of light emitting sections.

Accordingly, it is possible to achieve a desired light distribution characteristic by controlling as appropriate luminous flux and luminance of each of the plurality of light emitting sections.

### (Positional Relation Between Laser Beam-Irradiated Areas)

With regard to a case where a plurality of optical fibers are used, the following describes a positional relation between laser beam-irradiated areas, with reference to FIG. 4(a) and (b).

Note here that an area on a laser beam-irradiated surface 7a of a light emitting section 7, which area is irradiated with a laser beam L0 emitted through one emitting end, is referred to as a laser beam-irradiated area.

In the example of FIG. 4(a) and (b), there are two optical fibers 51 and 52. Accordingly, two laser beam-irradiated areas are formed. FIG. 4(a) is a distribution chart showing light intensity distributions for (i) a laser beam L0 emitted through the emitting end 51a of the optical fiber 51 and (ii) a laser beam L0 emitted through the emitting end 52a of the optical fiber 52. FIG. 4(b) is a view schematically illustrating a positional relation between two laser beam-irradiated areas 43 and 44 (i.e., irradiated areas: different areas).

In FIG. 4(a), a curve 41 represents the light intensity distribution of the laser beam L0 emitted through the emitting end 51a of the optical fiber 51. Similarly, a curve 42 represents the light intensity distribution of the laser beam L0 emitted through the emitting end 52a of the optical fiber 52. In the graph of FIG. 4(a), a horizontal axis indicates respective positions of the optical fibers 51 and 52. On the other hand, a vertical axis indicates respective light intensities of the laser beams L0 which strike the laser beam-irradiated surface 7a.

As illustrated in FIG. 4(a), a laser beam L0 emitted through one emitting end spreads at a predetermined angle so as to reach the laser beam-irradiated surface 7a. Therefore, even if the emitting ends 51a and 52a of the optical fibers 51 and 52 respectively are adjacently arranged on a plane parallel to the laser beam-irradiated surface 7a, the laser beam-irradiated areas 43 and 44, which are formed by the laser beams L0 emitted from the emitting end 51a and the emitting end 52a, respectively, may overlap each other (see (b) of FIG. 4).

Even in this case, it possible to irradiate the laser beam-irradiated surface 7a with the laser beams L0 such that the laser beams L0 are dispersed two-dimensionally, in the following manner. That is, the laser beams L0 strike the laser beam-irradiated surface 7a of the light emitting section 7 such that maximum intensity portions of the respective laser beams L0 emitted through the emitting ends 51a and 52a do not overlap each other, each of which portions has a highest light intensity in light intensity distribution of a corresponding one of the laser beams L0 (i.e., such portions are represented by parts of the curves 41 and 42 in the vicinity of central axes 41a and 42a).

In other words, (i) a laser beam L0 emitted through one of a plurality of emitting ends forms a projection image on the light emitting section 7 and (ii) a portion (i.e., a center of the laser beam-irradiated area), of the projection image, which has a highest light intensity in the projection image (such a portion is referred to as a highest light intensity portion) should not overlap that of another projection image formed by another laser beam L0 emitted through another one of the plurality of emitting ends. Therefore, the laser beam-irradiated areas does not necessarily have to be completely separated from each other.

In a case where the laser beams L0 overlap each other, a light intensity of an area where the laser beams L0 overlap each other may be higher than that of the highest light intensity portion. In order to avoid such a situation, positions of the highest light intensity portions should be adjusted so that an intersection of the curves 41 and 42 in the vicinity of a center of the distribution chart is one-half the light intensity of the highest light intensity portion. This is described later.

### (Deterioration of Light Emitting Section 7)

The inventor of the present invention found that exciting a light emitting section 7 by a high-power laser beam L0 led to a serious deterioration of the light emitting section 7. The following discusses the deterioration of the light emitting section 7.

The deterioration of the light emitting section 7 is caused mainly by a deterioration of a fluorescent material itself contained in the light emitting section 7, and a deterioration of a substance (e.g., silicone resin) surrounding the fluorescent material. While the sialon fluorescent material and the nitride fluorescent material emit light at efficiency from 60% to 90% in response to a laser beam L0, the other 40% to 10% is discharged as heat. It is considered that the heat causes the deterioration of the substance surrounding the fluorescent material.

In view of the problem, according to the examples of FIG. 2(b) and FIG. 4(a) and (b), laser beams L0 emitted through the emitting end 51 of the optical fiber 51 and through the emitting end 52a of the optical fiber 52 strike the respective different areas on the laser beam-irradiated surface 7a of the light emitting section 7. In other words, laser beams L0 emitted through a respective plurality of emitting ends are not concentrated on a point of the laser beam-irradiated surface 7a but dispersed two-dimensionally so that the laser beam-irradiated surface 7a is modestly irradiated with the laser beams L0.

This makes it possible to reduce a possibility that the light emitting section 7 is seriously deteriorated because a point on the light emitting section 7 is irradiated with the laser beams L0 in a concentrated manner. In addition, it is possible to prevent the deterioration of the light emitting section 7 without causing a decrease in luminous flux of the light emitting section 7. This makes it possible to realize a long-life laser downlight system 100 while achieving luminance required for the laser downlight system 100.

Further, since a life of the light emitting section 7 is increased, it is possible to reduce labor and costs required for replacement of the light emitting sections 7.

Further, changing an arrangement of the plurality of emitting ends with respect to the laser beam-irradiated surface 7a of the light emitting section 7 makes it possible to change illuminance in an area to be irradiated with light from the light emitting section 7.

### (Emission Intensity of Light Emitting Section 7)

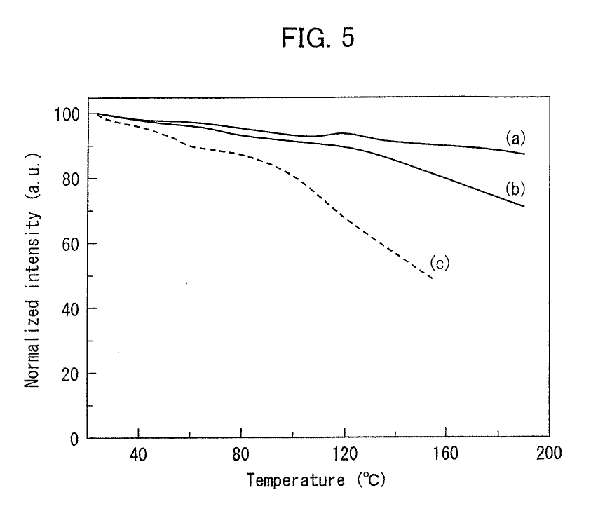

The following description discusses, with reference to FIG. 5, emission intensity obtained in a case where a light emitting section 7 is constituted by each of a various fluorescent materials. FIG. 5 is a graph showing temperature characteristics versus emission intensity obtained in a case where the various fluorescent materials are irradiated with laser beams having identical light intensity. In FIG. 5, (a) represents a fluorescent material A which is represented by the chemical formula of Ca_{0.98}Eu_{0.02}AlSiN₃, (b) represents a fluorescent material B which is represented by the chemical formula of Ca_{0.95}Eu_{0.5}AlSiN₃, and (c) represents a YAG:Ce³⁺ fluorescent material (produced by Kasei Optonics, Ltd., Product No. P46-Y3) obtained by introducing cerium Ce³⁺ serving as an activator to yttrium aluminate (Y₃Al₅O₁₂:YAG). The fluorescent materials A and B are examples of the nitride fluorescent material. In FIG. 5, a vertical axis indicates normalized intensity (a.u.), and a horizontal axis indicates temperature (° C.).

As is clear from (c) in FIG. 5, in a case of the YAG:Ce³⁺ fluorescent material, emission intensity of the light emitting section 7 at approximately 150° C. is approximately 60% of that obtained at room temperature (i.e., 30° C.). On the other hand, as is clear from (a) and (b) in FIG. 5, in a case of the fluorescent materials A and B, emission intensities of the light emitting section 7 at approximately 150° C. are approximately 90% and 83% of that obtained at room temperature (i.e., 30° C.), respectively. That is, it is preferable that the light emitting section 7 include a fluorescent material such as the nitride fluorescent material or the sialon fluorescent material, whose emission intensity is not so much affected by a temperature rise that is due to the irradiation with the laser beam L0.

However, as shown in FIG. 5, the emission intensity (light emission efficiency) of the light emitting section 7 decreases as a temperature rises even if the light emitting section 7 includes the nitride fluorescent material or the sialon fluorescent material. In particular, since the present embodiment employs, as excitation light, a laser beam L0 having a high intensity (unit: watt), a temperature of the light emitting section 7 including the nitride fluorescent material or the sialon fluorescent material would increase dramatically. That is, it is considered that even in a case of the light emitting section 7 including the nitride fluorescent material or the sialon fluorescent material, the emission efficiency of the light emitting section 7 decreases as a temperature dramatically increases, thereby eventually causing a deterioration in the light emitting section 7.

In view of this, the laser downlight system 100 of the present embodiment cools temperature rising areas of light emitting sections 7 with use of the cooling unit 20 and the nozzles 21. The laser downlight system 100 thus suppresses a temperature rise of the light emitting sections 7, thereby preventing a decrease in emission efficiency of nitride fluorescent materials or sialon fluorescent materials (and also a deterioration in the light emitting sections 7).

### (Air Volume Control by Air Volume Control Unit 70)

The following description discusses how an air volume is controlled by the air volume control unit 70.

As described above, the air volume control unit 70 of FIG. 1 controls, in accordance with electric power to be supplied to each of the laser diodes 3 by the power source unit 221 of the LD light source unit 220, the cooling unit 20 so that the cooling unit 20 generates a controlled volume of an air current.

The cooling unit 20 is preferably configured so as to control a volume of an air current for each of the light emitting unit 210A, the light emitting unit 210B, . . . and so on.

As is clear from FIG. 5, if the temperature of the temperature rising area of the light emitting section 7 exceeds approximately 120° C., the following occurs; that is, even if the light emitting section 7 includes the sialon fluorescent material and the nitride fluorescent material, the emission intensity of the light emitting section 7 becomes lower than an emission intensity that is approximately 90% of that obtained at room temperature (30° C.).

In view of this, a volume of an air current that the cooling unit 20 should generate can be found as follows. First, an air volume, with which it is possible to keep a temperature of the temperature rising area below 120° C. even in a case where an optical output power of a laser diode 3 is set to maximum, is referred to as an upper limit (first air volume) of an air volume.

Further, electric power, which is supplied to the laser diode 3 in this case, is referred to as an upper limit (first electric power) of electric power.

Next, another air volume (second air volume) is found. The second air volume is an air volume with which it is possible to keep the temperature of the temperature rising area below 120° C. in a case where electric power supplied to the laser diode 3 is certain electric power (second electric power) which is less than the upper limit.

Lastly, a straight line passing through two points respectively indicated by first coordinates (first electric power, first air volume) and second coordinates (second electric power, second air volume) is found. The straight line thus found indicates a volume of an air current that the cooling unit 20 should generate, which volume depends on electric power to be supplied to the laser diode 3.

How the air volume control unit 70 controls an air volume is not limited to the aforementioned method, and can be any method provided that the object can be achieved.

### (Configuration of Laser Diode)

The following describes a basic configuration of the laser diodes 3. FIG. 6(a) is a view schematically illustrating a circuit diagram of the laser diode 3. FIG. 6(b) is a perspective view illustrating a basic configuration of the laser diode 3. As illustrated in FIG. 6, the laser diode 3 is configured such that a cathode electrode 19, a substrate 18, a clad layer 113, an active layer 111, a clad layer 112, and an anode electrode 17 are stacked in this order.

The substrate 18 is a semiconductor substrate. In order to obtain excitation light such as from blue excitation light to ultraviolet excitation light so as to excite a fluorescent material as in the present invention, it is preferable that the substrate 18 be made of GaN, sapphire, and/or SiC. Generally, for example, a substrate for the laser diode is constituted by: a IV group semiconductor such as that made of Si, Ge, or SiC; a III-V group compound semiconductor such as that made of GaAs, GaP, InP, AlAs, GaN, InN, InSb, GaSb, or AlN; a II-VI group compound semiconductor such as that made of ZnTe, ZeSe, ZnS, or ZnO; oxide insulator such as ZnO, Al₂O₃, SiO₂, TiO₂, CrO₂, or CeO₂; or nitride insulator such as SiN.

The anode electrode 17 injects an electric current into the active layer 111 via the clad layer 112.

The cathode electrode 19 injects, from a bottom of the substrate 18 and via the clad layer 113, an electric current into the active layer 111. The electrical current is injected by applying forward bias to the anode electrode 17 and the cathode electrode 19.

The active layer 111 is sandwiched between the clad layer 113 and the clad layer 112.

Each of the active layer 111 and the clad layers 112 and 113 is constituted by, so as to obtain excitation light such as from blue excitation light to ultraviolet excitation light, a mixed crystal semiconductor made of AlInGaN. Generally, each of an active layer and clad layer of the laser diode is constituted by a mixed crystal semiconductor, which contains as a main composition Al, Ga, In, As, P, N, and/or Sb. The active layer 111 and clad layers 112 and 113 can also be constituted by such a mixed crystal semiconductor. Alternatively, the active layer 111 and clad layers 112 and 113 can be constituted by a II-VI group compound semiconductor such as that made of Zn, Mg, S, Se, Te, and/or ZnO.

The active layer 111 emits light upon injection of the electric current thus injected. The light emitted from the active layer 111 is kept within the active layer 111 due to a difference between a refractive index of the active layer 111 and that of each of the clad layer 112 and the clad layer 113.

The active layer 111 further has a front cleavage surface 114 and a back cleavage surface 115, which face each other so as to keep, within the active layer 111, light that is enhanced by induced emission. The front cleavage surface 114 and the back cleavage surface 115 serve as mirrors.

Note however that, unlike a mirror that totally reflects light, the front cleavage surface 114 and the back cleavage surface 115 (for convenience of description, these are collectively referred to as the front cleavage surface 114 in the present embodiment) of the active layer 111 transmit part of the light enhanced due to induced emission. The light emitted outward from the front cleavage surface 114 is a laser beam L0. The active layer 111 can have a multilayer quantum well structure.

The back cleavage surface 115, which faces the front cleavage surface 114, has a reflection film (not illustrated) for laser emission. By differentiating reflectance of the front cleavage surface 114 from reflectance of the back cleavage surface 115, it is possible to cause most of the laser beam L0 to be emitted from a luminous point 103 of an end surface having low reflectance (e.g., the front cleavage surface 114).

Each of the clad layer 113 and the clad layer 112 can be constituted by: a n-type or p-type III-V group compound semiconductor such as that made of GaAs, GaP, InP, AlAs, GaN, InN, InSb, GaSb, or AlN; or a n-type or p-type II-VI group compound semiconductor such as that made of ZnTe, ZeSe, ZnS, or ZnO. The electrical current can be injected into the active layer 111 by applying forward bias to the anode electrode 17 and the cathode electrode 19.

A semiconductor layer such as the clad layer 113, the clad layer 112, and the active layer 111 can be formed by a generally known film formation method such as MOCVD (metalorganic chemical vapor deposition), MBE (molecular beam epitaxy), CVD (chemical vapor deposition), laser-ablation, or sputtering. Each metal layer can be formed by a generally known film formation method such as vacuum vapor deposition, plating, laser-ablation, or sputtering.

### (Principle of Light Emission of Light Emitting Section)

Next, the following description discusses a principle of a fluorescent material emitting light in response to a laser beam L0 emitted from the laser diode 3.

First, the fluorescent material contained in the light emitting section 7 is irradiated with a laser beam L0 emitted from the laser diode 3. In response to the laser beam L0, an energy state of electrons in the fluorescent material is excited from a low energy state into a high energy state (excitation state).

After that, since the excitation state is unstable, the energy state of the electrons in the fluorescent material returns to the low energy state (an energy state of a ground level or an energy state of an intermediate metastable level between ground and excited levels) after a certain period of time.

As described above, the electrons excited to be in the high energy state returns to the low energy state. In this way, the fluorescent material emits light.

Note here that, white light can be made by mixing three colors which meet the isochromatic principle or by mixing two colors which are complimentary colors for each other. The white light can be obtained by combining (i) a color of a laser beam L0 emitted from a laser diode 3 and (ii) a color of light emitted from a fluorescent material on the basis of the foregoing principle and complementary relationship.

In a case where the laser diode 3 irradiates a light emitting section 7 with a laser beam L0 having a wavelength of 405 nm (output: 1 W), the light emitting section 7 emits luminous flux of 150 μm (lumen).

Since one (1) light emitting section 7 is irradiated with laser beams L0 emitted from a plurality of laser diodes 3 like above, it is possible to achieve a light emitting section 7 having high luminous flux and high luminance while preventing the light emitting section 7 from being damaged and/or deteriorated.

### (Another Configuration of Laser Diode)

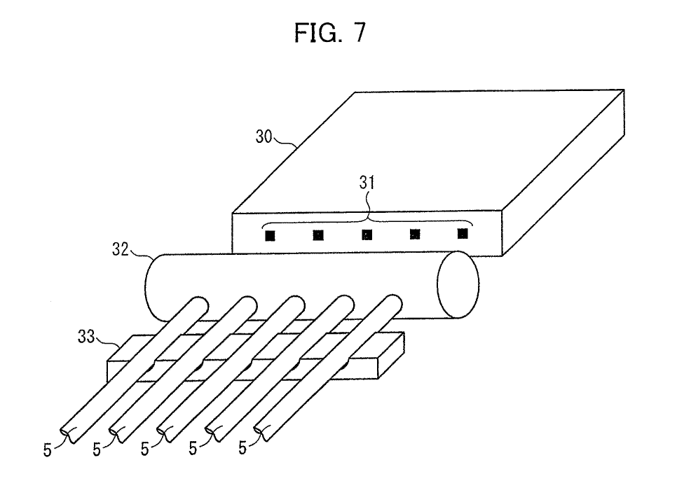

The following description discusses another example of the present invention, with reference to FIG. 7.

Each of the laser diodes 3 is configured such that one (1) luminous point is provided on one (1) chip. Alternatively, a laser source of the laser downlight system 100 can be a laser diode configured such that a plurality of luminous points are provided on one (1) chip.

FIG. 7 is a perspective view illustrating how a laser diode 30 is configured. As illustrated in FIG. 7, the laser diode 30 is configured such that five luminous points 31 are provided on one (1) chip. Each of the luminous points 31 emits a laser beam L0 having a wavelength of 405 nm. An optical output power of each of the luminous points 31 is 1 W, and total optical output power of the one chip is 5 W. The luminous points 31 are provided at intervals of 0.4 mm.

In a case where such a laser diode 30 is employed, a rod-shaped lens 32 is provided so as to face a surface, of the laser diode 30, on which the luminous points 31 are provided. The rod-shaped lens 32 causes the laser beams L0 emitted from the luminous points 31 to enter the optical fibers 5 through their entrance ends 5b. Although aspheric lenses 4 can be provided for the respective luminous points 31, the use of the rod-shaped lens 32 makes it possible to simplify the configuration of a light source.

An optical fiber holder 33 is the one for holding the plurality of entrance ends 5b so that the laser beams L0 emitted from the luminous points 31 strike the respective entrance ends 5b. Since the luminous points 31 are provided at intervals of 0.4 mm, the entrance ends 5b are held by the optical fiber holder 33 so that they are arranged also at intervals of 0.4 mm. For this purpose, the optical fiber holder 33 has grooves arranged at a pitch of 0.4 mm.

The configuration of the emitting ends 5a of the optical fibers 5 is the same as that of the aforementioned laser downlight system 100.

With use of the laser diode 30 like above, it is possible to simplify a structure of the laser source. This makes it possible to reduce production costs of the laser source.

### 2. Second Embodiment

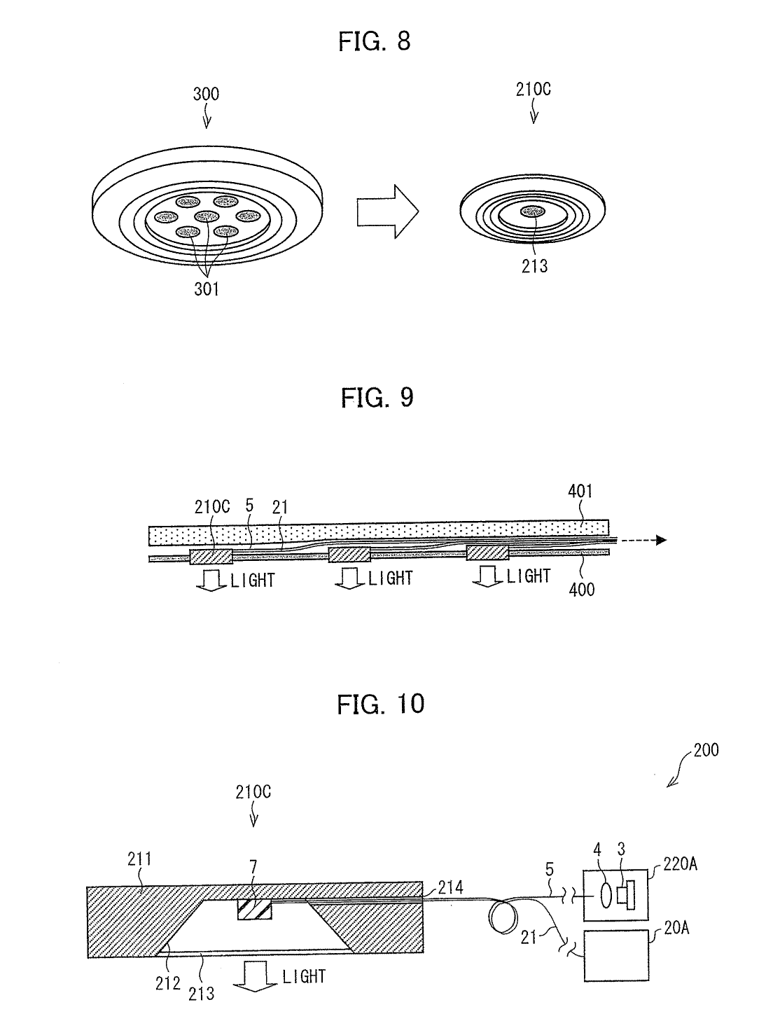

The following description discusses another embodiment of the present invention with reference to FIGS. 8 through 13.

The following description discusses a laser downlight (laser downlight system) 200, which is another embodiment of the present invention.

As illustrated in FIG. 10, the laser downlight system 200 of the present embodiment is different from the laser downlight system 100 of the first embodiment in that the laser downlight system 200 includes only one (1) light emitting unit and does not include a constituent equivalent to the air volume control unit 70.

Note, however, that needless to say that the laser downlight system 200 of the present embodiment can include a constituent equivalent to the air volume control unit 70 of the laser downlight system 100.

The laser downlight 200 is an illuminating device which is to be installed on a ceiling of a structural object such as a house or a vehicle. The laser downlight 200 uses, as illumination light, fluorescence that a light emitting section 7 generates in response to a laser beam L0 emitted from a laser diode 3.

Note that an illuminating device having a configuration same as that of the laser downlight 200 can be installed on a wall or on a floor of a structural object. Where to install the illuminating device is not particularly limited.

FIG. 8 is a view schematically illustrating overview of a light emitting unit 210C and overview of a conventional LED downlight 300. FIG. 9 is a cross-sectional view illustrating a ceiling on which the laser downlight 200 is installed. FIG. 10 is a cross-sectional view illustrating the laser downlight 200. As illustrated in FIGS. 8 through 10, the laser downlight 200 is recessed in a top board 400, and includes (i) the light emitting unit 210C which emits illumination light, (ii) an LD light source unit 220A which supplies a laser beam L0 to the light emitting unit 210C via an optical fiber 5, and (iii) a cooling device 20A which supplies an air current to the light emitting unit 210C via a nozzle 21 so as to cool the light emitting section 7. The LD light source unit 220A and the cooling device 20A are installed not on the ceiling but in another location (e.g., on a wall of a house) so that a user can readily reach the LD light source unit 220A and the cooling unit 20A. The LD light source unit 220A and the cooling device 20A are allowed to be installed in any location because the LD light source unit 220A and the cooling device 20A are connected with the light emitting unit 210C via the optical fiber 5 and the nozzle 21, respectively. The optical fiber 5 is provided in a gap between the top board 400 and a heat insulating material 401.

### (Configuration of Light Emitting Unit 210C)

As illustrated in FIG. 10, the light emitting unit 210C includes an outer housing 211, the optical fiber 5, the light emitting section 7, and a light transmitting plate 213.

Note that the light emitting unit 210C can be replaced by any one of the light emitting unit 210A of the first embodiment, the light emitting unit 210B of the first embodiment, and a later-described light emitting unit 210D.

The outer housing 211 has a recess part 212. The light emitting section 7 is provided on a bottom surface of the recess part 212. The recess part 212 functions as a reflection mirror because a surface of the recess part 212 is covered with a shin metal film.

The outer housing 211 has a passageway 214 which the optical fiber 5 and the nozzle 21 are caused to pass through. The optical fiber 5 and the nozzle 21 extend through the passageway 214 so as to reach the light emitting section 7. Relative positions of an emitting end 5a of the optical fiber 5 and an exit part 21a of the nozzle 21 with respect to the light emitting section 7 are same as that described in the first embodiment.

Note that, although the light emitting unit 210C of the present embodiment does not include a ferrule for holding the emitting end 5a of the optical fiber 5, such a configuration, in which the optical fiber 5 and the nozzle 21 are held only by means of the passageway 214, can also be employed.

The light transmitting plate 213 is a transparent or semitransparent plate provided so as to cover an opening of the recess part 212. The light transmitting plate 213 is same as that described in the first embodiment. The fluorescence emitted from the light emitting section 7 passes through the light transmitting plate 213 and is emitted outward as illumination light. The light transmitting plate 213 can be detachably provided to the outer housing 211 and can be omitted.

Although a peripheral part of the light emitting unit 210C has a circular shape according to FIG. 8, the light emitting unit 210C (more technically, the outer housing 211) is not particularly limited as to its shape.

Note that a downlight is not required to have an ideal point light source unlike a headlamp. Therefore, it is satisfactory if the downlight has one (1) luminous point. For this reason, a shape, size, and position of the light emitting section 7 are less restricted than those of the headlamp.

(Configuration of LD Light Source Unit 220a)

The LD light source unit 220A includes the laser diode 3, an aspheric lens 4, and the optical fiber 5.

Note here that, although FIG. 10 does not illustrate a constituent equivalent to a power supply unit 221 in the LD light source unit 220A, the following description is based on the assumption that the constituent equivalent to the power supply unit 221 is provided inside or outside the LD light source unit 220A.

Further, although the LD light source unit 220 of the first embodiment includes a plurality of sets of the laser diode 3, the aspheric lens 4, and the optical fiber 5, the LD light source unit 220A of the present embodiment includes only one (1) set of the laser diode 3, the aspheric lens 4, and the optical fiber 5. This is because, according to the present embodiment, there exists only one (1) light emitting unit 210C (or one (1) light emitting section 7).

Meanwhile, an incidence end 5b, which is one end of the optical fiber 5, is connected with the LD light source unit 220A. A laser beam L0 emitted from the laser diode 3 passes through the aspheric lens 4 and then enters the optical fiber 5 through the incidence end 5b.

Although FIG. 10 illustrates only one (1) pair of the laser diode 3 and the aspheric lens 4 provided inside the LD light source unit 220A, it is possible to employ the following configuration in a case where there are a plurality of light emitting units. That is, optical fibers 5 extending from the respective plurality of light emitting units are guided to one (1) LD light source unit 220A. According to this configuration, the LD light source unit 220A includes a plurality of pairs of the laser diode 3 and the aspheric lens 4 (or a combination of a plurality of laser diode 3 and a rod-shaped lens (not illustrated)). Accordingly, the LD light source unit 220A serves as a concentrated power source box as is the case with the LD light source unit 220 of the first embodiment.

### (Modification of how Laser Downlight 200 is Installed)

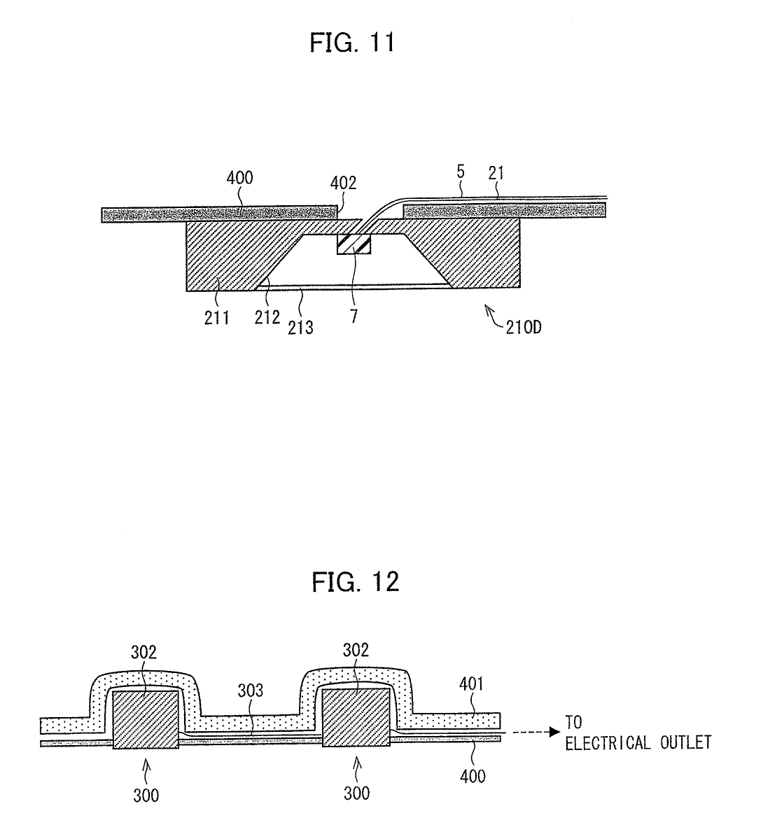

FIG. 11 is a cross-sectional view illustrating a modification of how the laser downlight 200 is installed. As illustrated in FIG. 11, how the laser downlight 200 is installed can be modified such that (i) the top board 400 has only a small hole 402 which the optical fiber 5 and the nozzle 21 are caused to pass through and (ii) a main body (a light emitting unit 210D) of the laser downlight, which is thin and light, is attached to the top board 400. This reduces restrictions on installation of the laser downlight 200, and thus makes it possible to dramatically reduce construction costs.

### (Comparison Between Laser Downlight 200 and Conventional LED Downlight 300)

As illustrated in FIG. 8, a conventional LED downlight 300 includes a plurality of light transmitting plates 301, through each of which illumination light is emitted. That is, the LED downlight 300 has a plurality of luminous points. This is because, since each of the luminous points produces relatively low light flux, it is necessary to provide the plurality of luminous points so as to produce luminous flux sufficient for illumination light.

In contrast, since the laser downlight 200 is an illuminating device which produces high luminous flux, the laser downlight 200 only needs one (1) luminous point. Accordingly, the laser downlight 200 can create a sharply defined shadow. Further, in a case where a fluorescent material of the light emitting section 7 is the one having a high color rendering property (e.g., a combination of several types of oxynitride fluorescent materials), it is possible to increase a color-rendering property of illumination light.

This makes it possible to achieve a color rendering property almost as high as that of the incandescent bulb downlight. For example, it is difficult for an LED downlight or a fluorescent downlight to obtain a light having a high color rendering property, i.e., to have not only an average color rendering index Ra of 90 or greater but also a special color rendering index R9 of 95 or greater. In this regard, with a combination of a fluorescent material having a high color rendering property and the laser diode 3, it is possible to obtain such a light having a high color rendering property.

Note here that the special color rendering index R9 is an index for evaluating reproducibility of red color. The special color rendering index R9 may be equal to or less than 0 (i.e., negative value) in a case of a pseudo-white LED. In contrast, as described above, the laser downlight 200 of the present embodiment has the special color rendering index R9 of 95 or greater. This indicates that the laser downlight 200 has an extremely excellent color rendering property.

FIG. 12 is a cross-sectional view illustrating a ceiling on which the conventional LED downlight 300 is installed. As illustrated in FIG. 12, the LED downlight 300 is configured such that an outer housing 302, in which an LED chip, a power source, and a cooling unit are contained, is recessed in a top board 400. The outer housing 302 is relatively large in size. A heat insulating material 401 has a recess part at a position corresponding to the outer housing 302 so as to fit a shape of the outer housing 302. A power source line 303 extends from the outer housing 302 and is connected with an electrical outlet (not illustrated).

According to the configuration, the following problems occur. First, a light source (LED chip) and the power source, which are sources of heat generation, are provided between the top board 400 and the heat insulating material 401. Therefore, use of the LED downlight 300 increases a temperature of the ceiling, thereby reducing cooling efficiency of a room.

Further, since the LED downlight 300 requires a power source for each light source, total costs are increased.

Further, since the outer housing 302 is relatively large in size, it is often difficult to install the LED downlight 300 in a gap between the top board 400 and the heat insulating material 401.

In contrast, the light emitting unit 210C of the laser downlight 200 does not include a large source of heat generation. Therefore, cooling efficiency of a room is not reduced, thereby making it possible to avoid an increase in costs of cooling efficiency of a room.

Further, even in a case where there are a plurality of light emitting units 210C, it is not necessary to provide a power source for each of the plurality of light emitting units 210C. Therefore, it is possible to achieve a small and thin laser downlight 200. This reduces restrictions on a space in which the laser downlight 200 is to be installed, and allows for easy installation into an already-built house.

Furthermore, since the laser downlight 200 is small and thin, the light emitting unit 210C can be installed on a surface of the top board 400 as described above. This makes it possible to reduce restrictions on installation as compared with the LED downlight 300 and to dramatically reduce construction costs.

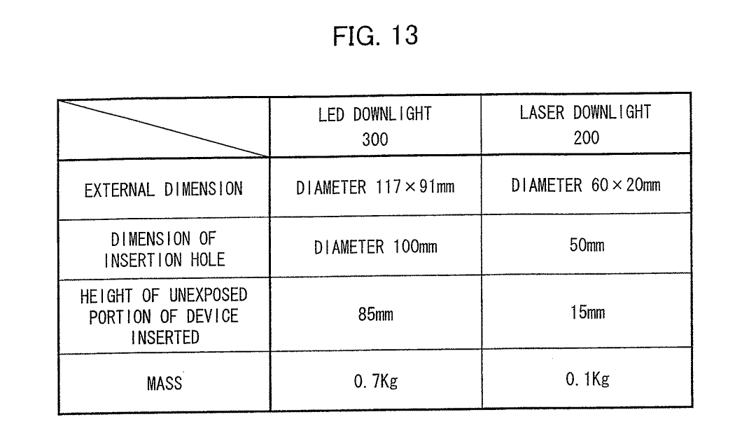

FIG. 13 is a table for comparing specifications of the laser downlight 200 and the LED downlight 300. As is clear from FIG. 13, for example, the laser downlight 200 has volume of 94% less than that of the LED downlight 300 and mass of 86% less than that of the LED downlight 300.

Further, the LD light source unit 220 can be installed so that a user can readily reach the LD light source unit 220. This allows for easy replacement of the laser diode 3 even if the laser diode 3 is broken. Similarly, the cooling device 20A can be installed so that the user can readily reach the cooling device 20A. This allows for easy repair of the cooling device 20A even if a cooling mechanism inside the cooling device 20A is broken. Furthermore, it is possible to cause optical fibers 5 to extend from a plurality of light emitting units to one (1) LD light source unit 220. This makes it possible to collectively manage a plurality of laser diodes 3, thereby making it possible to easily replace two or more of the plurality of laser diodes 3 simultaneously.

Note here that, in a case where the LED downlight 300 is the one including a fluorescent material having a high color rendering property, the LED downlight 300 is capable of producing luminous flux of approximately 500 1 m with electric power consumption of 10 W. On the other hand, in order for the laser downlight 200 to achieve same luminous flux, the laser downlight 200 needs to have an optical output power of 3.3 W. The optical output power of 3.3 W corresponds to electric power consumption of 10 W in a case where efficiency of LD is 35%. Meanwhile, the LED downlight 300 consumes electric power of 10 W. That is, the LED downlight 300 and the laser downlight 200 are not so different from each other in terms of electric power consumption. That is, the laser downlight 200 can achieve the foregoing various advantages with electric power consumption same as that of the LED downlight 300.

As has been described, the laser downlight 200 includes: an LD light source unit 220A including at least one (1) laser diode 3 which emits a laser beam L0; at least one (1) light emitting unit 210C including a light emitting section 7 and having a recess part 212 serving as a reflection mirror; an optical fiber 5 which guides the laser beam L0 to the at least one (1) light emitting units 210C; and a cooling device 20A which cools the light emitting section 7 of the at least one (1) light emitting units 210C. Further, the laser downlight 200 is configured such that its including cooling device 20A generates an air current, and further includes a nozzle 21 which sends the air current generated by the cooling device 20A to the light emitting section 7.

Accordingly, in the laser downlight 200, it is possible to suppress an increase in a temperature of an irradiated area, of the light emitting section 7, which is irradiated with the laser beam L0. This makes it possible to achieve a long-life laser downlight 200.

The present invention can be also expressed as follows.

That is, a laser downlight in accordance with the present invention can be configured such that (i) a light emitting section which serves as a downlight section (light emitting section) for emitting illumination light and includes mainly a fluorescent material and an outer housing in which the fluorescent material is contained, (ii) a laser diode element (laser source) which emits a laser beam, (iii) a power supply circuit (electric power control section) which drives the laser diode element, and (iv) a cooling device (cooling section) are optically connected with one another via a light guide (light guide section) having flexibility such as an optical fiber.

This makes it possible to provide a downlight (described later) which (i) consumes markedly low electric power as compared with a conventional downlight so that the electric power consumed is equivalent to that of an LED downlight which is said to consume low electric power and (ii) has many advantages in addition to the low electric power consumption. Note here that, from a viewpoint of total heating and lighting expenses, one of such advantages, in which cooling efficiency of a room is not reduced, will further reduce electric power consumption as compared with the LED downlight.

Moreover, in a case of making an illumination system including a plurality of downlights, which illumination system is thought to be widely employed, the following configuration is available according to a downlight of the present invention. That is, according to the downlight of the present invention, a plurality of laser diodes can be put together, and a power supply circuit and a cooling device can be shared by the plurality of laser diodes. This makes it possible to reduce electric power consumption as compared with a conventional LED downlight, which includes a power supply circuit for each illuminating device.

Further, the downlight of the present invention includes, as an excitation light source, a laser diode which has an optical output power higher than that of an LED. Therefore, it is possible for the downlight to achieve a sufficient lighting intensity without having a plurality of luminous points. This makes it possible to achieve a high-grade downlight which is capable of creating a sharply-defined shadow same as that by an incandescent bulb such as a conventional miniature krypton bulb. Note here that a conventional fluorescent downlight cannot create a sharply-defined shadow, because the fluorescent downlight has an extremely large light emitting section.

Further, the downlight of the present invention can employ a combination of a fluorescent material having a high color rendering property and a laser diode which has an emission wavelength of around 405 nm. This makes it possible to achieve a high color rendering property almost as high as that of the incandescent bulb downlight. For example, it is difficult for an LED downlight or a fluorescent downlight to obtain a light having a high color rendering property, i.e., to have not only an average color rendering index Ra of 90 or greater but also a special color rendering index R9 of 95 or greater. In this regard, with the combination of the fluorescent material having a high color rendering property and the laser diode, it is possible to obtain such a light having a high color rendering property.

Further, the downlight section (light emitting section) installed on the ceiling and an excitation light source section including the laser diode can be optically connected with each other via an optical fiber etc. having flexibility so as to be spatially separate from each other. This makes it possible to prevent much heat from being radiated in a space above a ceiling (e.g., a gap between the top board and the heat insulating material), thereby making it possible to prevent a reduction in cooling efficiency of a room. This is achieved because the laser diode and the power supply circuit, which are main heat generation sources, are removed from the space above the ceiling. Note here that, in a case of a conventional downlight (an incandescent bulb downlight or a fluorescent downlight), main heat generation sources are light sources themselves. In a case of an LED downlight, main heat generation sources are an LED element and a power supply circuit for converting between alternating and direct currents.

Further, since the laser diode serving as the excitation light source, a corresponding power supply circuit, and a cooling device therefor are removed from the space above the ceiling, an extremely small and light downlight section (light emitting section) can be achieved. This allows for easy substitution of an illuminating device in a room by a downlight even in the course of renovation of an already-built house which originally has not taken into consideration the installation of the downlight.

As has been described, it is possible to provide a downlight which consumes less electric power (equivalent to that of an LED downlight) as compared with a conventional incandescent bulb. Further, it is possible to provide a low-power-consumption downlight which has only one (1) luminous point and therefore is possible to create a shapely-defined shadow. Further, it is possible to provide a downlight which does not reduce cooling efficiency of a room and thus keeps a comfortable temperature during the summer. Further, it is possible to provide a downlight which can be easily installed even in the course of renovation of an already-built house (i.e., easily installed even after a house has been built).

Further, on the one hand a downlight is used alone, on the other hand a plurality of downlights are used in combination in many cases. In such cases, a power supply circuit can be shared by the plurality of downlights. This makes it possible to provide a downlight system capable of reducing electric power consumption and device costs as compared with those of a conventional LED downlight, in which a power supply circuit is provided for each LED downlight.

Further, it is possible to provide a downlight and a downlight system each of which has an extremely high color rendering property, which is a great advantage of the incandescent bulb downlight.

That is, it is possible to achieve a downlight and a downlight system each of which has a color rendering property almost as high as that of an incandescent bulb downlight, which property cannot be achieved by a fluorescent downlight or an LED downlight.

Further, the downlight in accordance with the present invention can include a light transmitting plate.

Further, the downlight in accordance with the present invention can be configured such that a light guide section(s) extends from a laser source(s) provided in one (1) location to corresponding light emitting sections provided in respective different positions.

Further, the downlight in accordance with the present invention can be configured such that the light guide section having one (1) incidence end, which is connected with the laser source, branches into two or more parts in a middle of the light guide section, and emitting ends of the respective parts face respective two or more light emitting sections.

Further, the laser downlight system in accordance with the present invention can be configured so as to include at least two laser downlights, and to further include an electric power control section capable of collectively controlling amounts of electric power to be supplied to a plurality of laser sources.

A laser downlight in accordance with the present invention can further include: a light transmitting member which transmits the light emitted from the light emitting section and blocks the laser beam emitted from said at least one laser source, the light transmitting member being provided on a path through which the light travels from the light emitting section to outside.

Note here that the laser beam emitted from the laser diode, which is an excitation light source and forms an extremely small luminous point, is increased in its size through the light emitting section. However, part of the laser beam may not be converted for some reasons. Even in this case, since the light transmitting member blocks the laser beam, it is possible to prevent the laser beam, which is emitted from the small luminous point, from leaking out.

The laser downlight in accordance with the present invention can be configured such that: said at least one laser source constitutes a laser source group; the number of said at least one emitting end is two or more; the light emitting section includes two or more light emitting sections; the light guide section (i) receives, through said at least one incidence end, the laser beam emitted from the laser source group and (ii) emits, through each of the two or more emitting ends, the laser beam received through said at least one incidence end; and each of the two or more light emitting sections emits light in response to the laser beam emitted through a corresponding one of the two or more emitting ends.

According to the configuration, the laser source group and the two or more light emitting sections, which are constituents independent from each other, are optically connected with each other via the light guide section. Therefore, a size of each of the two or more light emitting sections can be determined regardless of a size of the laser source group (or the laser source). This makes it possible to reduce the size of each of the two or more light emitting sections.

The laser downlight in accordance with the present invention can be configured such that the light guide section has a branch point at which an optical path through which the laser beam travels is divided.

According to the configuration, for example even in a case where (i) the light guide section includes a plurality of light guides and (ii) the number of the plurality of light guides is smaller than the number of the two or more light emitting sections, it is possible to avoid a situation in which there is a light emitting section(s) optically connected with none of the plurality of light guides by causing the plurality of light guides to have branch points so as to correspond to the two or more light emitting sections.

Note here that one (1) light guide can be branched into two parts or three or more parts.

For each of the light guides, an optical path of excitation light can be divided into two paths or three or more paths.

The laser downlight in accordance with the present invention can be configured such that the light guide section has flexibility.

According to the configuration, the light guide section includes a flexible material. An example of such a light guide section encompasses an optical fiber or a light guide tube having flexibility. This allows for an easy change of a positional relation between the incidence end and the emitting end of the light guide section, thereby allowing for easily change of a positional relation between the laser source and the light emitting section. Accordingly, it is possible to further improve design flexibility of the laser downlight. This makes it possible to provide a downlight that can be easily installed for example even in the course of renovation of an already-built house (i.e., easily installed even after a house has been built).

Meanwhile, according to a conventional incandescent bulb downlight and a conventional fluorescent downlight, their light sources themselves, such as an incandescent bulb and a fluorescent light, are main source of heat generation. This causes a secondary problem in which use of the downlight reduces cooling efficiency of a room.

In this regard, according to the laser downlight in accordance with the present invention, a downlight section (light emitting section) to be installed on a ceiling and the laser source can be optically connected with each other via for example an optical fiber having flexibility, and thus can be spatially separate from each other. As such, it is possible to prevent much heat from being radiated to a space above the ceiling (e.g., a gap between a top board and a heat insulating material).

This makes it possible to provide a downlight that does not reduce cooling efficiency of a room, and thus keeps a comfortable temperature during the summer. Further, from a viewpoint of total heating and lighting expenses, such an advantage, in which the cooling efficiency of a room is not reduced, will further reduce electric consumption as compared with the conventional LED downlight.

The laser downlight in accordance with the present invention can be configured such that: the number of said at least one laser source is two or more; the light guide section includes two or more light guide sections; and laser beams emitted from the two or more light guide sections through their emitting ends strike the light emitting section such that maximum intensity portions of the respective laser beams do not overlap each other, each of the maximum intensity portions having a highest light intensity in light intensity distribution of a corresponding one of the laser beams.

According to the configuration, the number of said at least one laser source is two or more and the light guide section includes two or more light guide sections. The laser beams are emitted from the two or more light guide sections through their emitting ends. Note here that, the laser beams emitted from the two or more light guide sections through their emitting ends strike the light emitting section such that the maximum intensity portions of the respective laser beams do not overlap each other, each of which portions has a highest light intensity in light intensity distribution of a corresponding one of the laser beams. In other words, the laser beams emitted from the two or more light guide sections through their respective emitting ends strike the light emitting section so as to be dispersed.

This makes it possible to reduce a likelihood that the light emitting section is significantly deteriorated due to intensive irradiation of a part of the light emitting section with the laser beams, and thus possible to achieve a long-life laser downlight without reducing luminous flux of the laser downlight. Further, since it is not necessary to reduce intensity of the laser beams emitted to the light emitting section, it is possible to increase not only luminous flux but also luminance of the laser downlight. As such, it is possible to achieve a small and high-luminance laser downlight.

A laser downlight in accordance with the present invention can further include: a convex lens having a convex surface that faces the light emitting section, the convex lens being provided between said at least one emitting end of the light guide section and the light emitting section.

According to the configuration, the convex lens, which has the convex surface facing the light emitting section, is provided between the emitting end of the light guide section and the light emitting section. This makes it possible to cause the laser beam to strike the light emitting section so that an area irradiated with the laser beam matches a size of the light emitting section, even in a case where the area is larger than the size of the light emitting section.

This makes it possible to cause the laser beam emitted from the light guide section through the emitting end to strike the light emitting section without loss of the laser beam. As such, it is possible to further reduce electric power consumption.

Examples of the “convex lens having the convex surface facing the light emitting section” encompass a biconvex lens, a plano-convex lens, and a convex meniscus lens, each of which has a convex surface facing the light emitting section.

A laser downlight in accordance with the present invention can further include: a concave lens having a concave surface that faces the light emitting section, the concave lens being provided between said at least one emitting end of the light guide section and the light emitting section.

According to the configuration, the concave lens, which has the concave surface facing the light emitting section, is provided between the emitting end of the light guide section and the light emitting section. This makes it possible to cause the laser beam to strike the light emitting section so that an area irradiated with the laser beam matches a size of the light emitting section, even in a case where the area is smaller than the size of the light emitting section.

This makes it possible to cause the laser beam emitted from the light guide section through the emitting end to strike the light emitting section without loss of the laser beams. As such, it is possible to further reduce electric power consumption.

Examples of the “concave lens having the concave surface facing the light emitting section” encompass a biconcave lens, a plano-concave lens, and a concave meniscus lens, each of which has a concave surface facing the light emitting section.

A laser downlight in accordance with the present invention can further include: a cooling section for cooling a temperature rising area that includes (i) an irradiated area, of the light emitting section, which is irradiated with the laser beam and (ii) vicinities of the irradiated area.

According to the configuration, the laser beam emitted from the laser source enters the light guide section through the incidence end and is emitted from the light guide section through the emitting end. The light emitting section emits the light in response to the laser beam. This causes a little increase in a temperature of an area which includes an irradiated area of the light emitting section and vicinities of the irradiated area (that is, such an area is referred to as the temperature rising area); however, the cooling section cools the temperature rising area.

Since an increase in the temperature of the temperature rising area is suppressed, it is possible to prevent a deterioration of the light emitting section due to heat generation. Accordingly, it is possible to achieve a long-life downlight whose life is as long as or longer than that of the LED downlight.

The laser downlight in accordance with the present invention can be configured such that: the cooling section includes: an air sending section for generating an air current to be sent to the temperature rising area; and an air guide section having (i) an entrance part through which the air guide section receives the air current generated by the air sending section and (ii) an exit part through which the air guide section ejects the air current received through the entrance part, the exit part being provided near the temperature rising area.

According to the configuration, the air current generated by the air sending section enters the air guide section through the entrance part, and is ejected from the air guide section through the exit part which is near the temperature rising area. This enables the laser downlight in accordance with the present invention to cause the air current generated by the air sending section to reach the temperature rising area. Accordingly, it is possible to cool the temperature rising area with the air current.

Further, it is possible to separate the cooling section from the light emitting section by a certain distance by for example changing a distance between the entrance part and the exit part of the air guide section as needed. This makes it possible to improve design flexibility of the laser downlight. As such, it is possible to provide a downlight that can be easily installed even in the course of renovation of an already-built house (i.e., easily installed even after a house has been built).

The laser downlight in accordance with the present invention can be configured such that the air guide section has flexibility.

According to the configuration, the air guide section has flexibility. This allows for easy change in a positional relation between the entrance part and the exit part, thereby allowing for easy change in a positional relation between the air sending section and the light emitting section. As such, it is possible to improve design flexibility of the laser downlight in accordance with the present invention.

As such, it is possible to provide a downlight that can be easily installed even in the course of renovation of an already-built house (i.e., easily installed even after a house has been built).

A laser downlight system in accordance with the present invention preferably includes: a plurality of laser downlights each of which is described above; and an electric power control section for collectively controlling amounts of electric power to be supplied to the laser sources of the plurality of laser downlights.

According to the configuration, the laser downlight system includes the electric power control section for collectively controlling amounts of electric power to be supplied to the laser sources. This makes it possible to collectively control electric power consumption for all of the plurality of laser downlights.

Meanwhile, on the one hand a downlight is used alone, on the other hand a plurality of downlights are used in combination. In such cases, for example the electric power control section can be shared by the plurality of downlights. This makes it possible to reduce electric power consumption and device costs as compared with a conventional LED downlight, in which an electric power control section is provided for each downlight.

Further, in a case of making a system including a plurality of downlights, it is possible to collectively supply electric power to a plurality of laser sources by one (1) electric power control section.

Further, the laser source and its electric power control section can be separated from a downlight section, i.e., it is not necessary that the laser source and electric power control section be installed in a space above a ceiling. This makes it possible to achieve a small and light downlight section, thereby allowing for easily substitution of an illuminating device in a room by a downlight system even in the course of renovation of an already-built house which originally has not taken into consideration the installation of the downlight

A laser downlight system in accordance with the present invention can include: at least one (1) laser downlight recited in claim 10; an electric power control section for controlling an amount of electric power to be supplied to said at least one laser source; and an air volume control section for controlling, in accordance with the amount of the electric power controlled by the electric power control section, a volume of an air current that the air sending section should generate.

According to the configuration, the laser downlight system includes the electric power control section which controls an amount of electric power supplied to the laser source. This makes it possible to control intensity of a light emitted from the laser downlight.

Further, the air volume control section controls, in accordance with the amount of the electric power controlled by the electric power control section, a volume of the air current that the air sending section should generate. This makes it possible to suppress excess electric power consumption due to generation of an unnecessary volume of an air current.

Also in this case, for example the electric power control section can be shared by the plurality of downlights. This makes it possible to reduce electric power consumption and device costs as compared with a conventional LED downlight, in which an electric power control section is provided for each downlight.

Further, in a case of making a system including a plurality of downlights, it is possible to collectively supply electric power to a plurality of laser sources by one (1) electric power control section.

Further, it is possible to supply the air current generated by the air sending section to each of a plurality of downlights through the air guide section. Accordingly, it is possible to dramatically reduce a size of the downlight section (light emitting section) as compared with a conventional downlight, in which a cooling unit is provided for each downlight.

Further, the laser source, the electric power control section, and the cooling section can be separated from a downlight section, i.e., a ceiling. This makes it possible to achieve a small and light downlight section, thereby allowing for easy substitution of an illuminating device in a room by a downlight system even in the course of renovation of an already-built house which originally has not taken into consideration the installation of the downlight.

### ADDITIONAL REMARK

The invention is not limited to the description of the embodiments above, but may be altered within the scope of the claims. An embodiment based on a proper combination of technical means disclosed in different embodiments is encompassed in the technical scope of the invention.

### INDUSTRIAL APPLICABILITY

The present invention is applicable to a laser downlight and a laser downlight system each of which is required to be small, produce high luminous flux, and consume less electric power.

### REFERENCE SIGNS LIST

3 Laser diode (Laser source)
5 Optical fiber (Light guide section)
5D Branched optical fiber (Light guide section)
5a Emitting end
5b Incidence end
7 Light emitting section
11, 12, 13 Laser source group
20 Cooling unit (Cooling section, Air sending section)
20A Cooling device (Cooling section, Air sending section)
21 Nozzle (Cooling section, Air guide section)
21a Exit part
21b Entrance part
30 Laser diode (Laser source)
31 Luminous point (Laser source)
40 Irradiation lens (Convex lens, Concave lens)
41 Elliptic cylindrical light emitting material (Light emitting section)
43 Laser beam-irradiated area (Irradiated area, Different areas)
44 Laser beam-irradiated area (Irradiated area, Different areas)
51 Optical fiber (Light guide section)
51a Emitting end
52 Optical fiber (Light guide section)
52a Emitting end
70 Air volume control unit (Air volume control section)
100 Laser downlight system (Laser downlight)
200 Laser downlight (Laser downlight system)
210 Light emitting unit group (Laser downlights)
210A Light emitting unit (Laser downlight)
210B Light emitting unit (Laser downlight)
210C Light emitting unit (Laser downlight)
210D Light emitting unit (Laser downlight)
221 Power supply unit (Electric power control section)

1. A laser downlight, comprising:
at least one (1) laser source for emitting a laser beam;
a light guide section having (i) at least one (1) incidence end through which the light guide section receives the laser beam emitted from said at least one laser source and (ii) at least one (1) emitting end through which the light guide section emits the laser beam received through said at least one incidence end; and
a light emitting section which emits light in response to the laser beam emitted through said at least one emitting end.

2. A laser downlight according to claim 1, further comprising:
a light transmitting member which transmits the light emitted from the light emitting section and blocks the laser beam emitted from said at least one laser source,
the light transmitting member being provided on a path through which the light travels from the light emitting section to outside.

3. The laser downlight according to claim 1, wherein:
said at least one laser source constitutes a laser source group;
the number of said at least one emitting end is two or more;
the light emitting section includes two or more light emitting sections;
the light guide section (i) receives, through said at least one incidence end, the laser beam emitted from the laser source group and (ii) emits, through each of the two or more emitting ends, the laser beam received through said at least one incidence end; and
each of the two or more light emitting sections emits light in response to the laser beam emitted through a corresponding one of the two or more emitting ends.

4. The laser downlight according to claim 3, wherein the light guide section has a branch point at which an optical path through which the laser beam travels is divided.

5. The laser downlight according to claim 1, wherein the light guide section has flexibility.

6. The laser downlight according to claim 1, wherein:
the number of said at least one laser source is two or more;
the light guide section includes two or more light guide sections; and
laser beams emitted from the two or more light guide sections through their emitting ends strike the light emitting section such that maximum intensity portions of the respective laser beams do not overlap each other, each of the maximum intensity portions having a highest light intensity in light intensity distribution of a corresponding one of the laser beams.

7. A laser downlight according to claim 1, further comprising:
a convex lens having a convex surface that faces the light emitting section, the convex lens being provided between said at least one emitting end of the light guide section and the light emitting section.

8. A laser downlight according to claim 1, further comprising:
a concave lens having a concave surface that faces the light emitting section, the concave lens being provided between said at least one emitting end of the light guide section and the light emitting section.

9. A laser downlight according to claim 1, further comprising:
a cooling section for cooling a temperature rising area that includes (i) an irradiated area, of the light emitting section, which is irradiated with the laser beam and (ii) vicinities of the irradiated area.

10. The laser downlight according to claim 9, wherein:
the cooling section includes:
an air sending section for generating an air current to be sent to the temperature rising area; and
an air guide section having (i) an entrance part through which the air guide section receives the air current generated by the air sending section and (ii) an exit part through which the air guide section ejects the air current received through the entrance part,
the exit part being provided near the temperature rising area.

11. The laser downlight according to claim 10, wherein the air guide section has flexibility.

12. A laser downlight system, comprising:
a plurality of laser downlights each of which is recited in claim 1; and
an electric power control section for collectively controlling amounts of electric power to be supplied to the laser sources of the plurality of laser downlights.

13. A laser downlight system, comprising:
at least one (1) laser downlight recited in claim 10;
an electric power control section for controlling an amount of electric power to be supplied to said at least one laser source; and
an air volume control section for controlling, in accordance with the amount of the electric power controlled by the electric power control section, a volume of an air current that the air sending section should generate.
